(19) United States
(12) Patent Application Publication
(10) Pub. No.: US 2022/0374881 A1
(43) Pub. Date: Nov. 24, 2022

(54) Systems and Methods for Assurance Management

(71) Applicant: Gregory Fx Iannacci, Stoneham, MA (US)

(72) Inventor: Gregory Fx Iannacci, Stoneham, MA (US)

(21) Appl. No.: 17/749,514

(22) Filed: May 20, 2022

Related U.S. Application Data
(60) Provisional application No. 63/191,704, filed on May 21, 2021.

(51) Int. Cl. G06Q 20/38; G06Q 20/40

(52) U.S. Cl. CPC G06Q 20/389; G06Q 20/401; G06Q 50/10

(57) ABSTRACT

The present invention will process and combine data from transaction information and create a verifiable data record of the transaction with accompanying terms, conditions, provisions, and parties and perform operational ratings, rankings, probabilities, assignments, and tokenization in various distributed ledger storage systems. The present invention improves the operation of assurances by identifying complementary components that may be integrated, combined, extended, or transformed and thus provide consolidated holistic benefits for the user.

### CROSS-REFERENCE TO RELATED APPLICATIONS

This application is based upon U.S. Provisional Patent Application No. 63/191,704, entitled Assurance Management System and Methods, filed 21 May 2021, naming Gregory Fx Iannacci as inventor. The entirety of such provisional patent application is incorporated by reference herein.

### STATEMENT REGARDING FEDERALLY SPONSORED RESEARCH OR DEVELOPMENT

Not Applicable.

### REFERENCE TO A MICROFICHE APPENDIX

Not Applicable.

### REFERENCE PUBLICATIONS

U.S. Pat. No. 8,229,861, Trandal, et al.
U.S. Pat. No. 11,288,761, Blackburn, et al.
U.S. Pat. No. 11,288,280, Padmanabhan, et al.
U.S. Pat. No. 11,233,641, Soundararajan, et al.
U.S. Pat. No. 11,232,652, Blackburn, et al.
U.S. Pat. No. 11,216,823, Blackburn, et al.

### FIELD OF THE INVENTION

The present invention describes systems and methods for a reimagined role dealing with assurances and their management. Assurances include a range of topics, as example and not limitation: warranties, promises, guarantees, pledges, statements, contracts, commitments, gifts, policies, reservations, bequests, and performance declarations. These assurances are part of the everyday life of transactions and interactions, yet they are not comprehensively reviewed, analyzed, coordinated, combined, maintained, or readily available for reference or recommendation. The present invention provides a cohesive assurance solution that integrates combinable terms and operational savings for improved beneficiary value.

As an example, a sales receipt for a power tool (e.g., a drill purchased from Home Depot) is provided to a consumer, yet the receipt may not be retained for warranty repair presentation. Nor may the combination of any warranty policies associated with the sale be obviously conveyed to the consumer.

A cavalier attitude about reviewing and combining assurances leads to a burden on the beneficiary by their not being cognizant of assurance terms or their combination. As an example, a refund of payment may be denied without presenting a sales receipt to a merchant. Furthermore, a manufacturer may deny warranty repairs without proper purchase credentials. While a purchase transaction is one moment in time, an assurance continues for a period of time, activity, or condition and that is why authenticated credentials and the retention and knowledge of combined benefits of assurance policies are critical to provide a beneficiary with their best value by means of smart assurances.

The need for smart assurances will become more evident as technological innovation advances. In point of fact, the Internet of Things (IoT) encompassed 10 billion devices in 2018 and is projected to reach 64 billion by 2025 and possibly many trillions by 2040, all monitored in real time (ref: Global Trends 2040). IoT will allow for product warranties based on aspects other than simple time durations, such as a 2 year warranty.

Assurances may be based on diverse aspects of operational and environmental conditions such as: operating time; button clicks; chemical exposure; number of operating cycles; voltage; torque levels; temperature; humidity; and vibration levels to name only a few possibilities. Products and services equipped with an IoT “black box” data recorder and transmitter will be enabled to monitor and transmit such various conditions. Such environmental data affecting assurances will need coordination and management to best serve the beneficiary. On one level, beneficiaries in the IoT realm will need to have a smart assurance management system in an age of pervasive connectedness in order to know, review, integrate, and advance their claims.

Addressing such attributes as the usefulness, terms, duration, activity, and reliability of assurances, as well as other assurance traits, and the entities involved with such assurances, is provided by the present invention's improved means of authenticating, organizing, analyzing, integrating, tokenizing, and managing assurances. A further benefit of the present invention includes, among other features, efficiency in contemporaneous safety recalls and notifications of importance.

An additional innovative feature allows the present invention to review individual transaction data in various beneficiary combinations of similar or related assurances and produce cohorts that petition assurance providers for enhanced assurance policies in dynamic fashion. A further embodiment aggregates assurance policies from providers (e.g., merchants, manufacturers, airlines, nail salons) and subscribers of the present invention into a searchable collection for query by users.

A further innovative feature involves affinity, group, and membership programs. A merchant or group may offer a loyalty or affinity membership syndicate program such that transactions may qualify for additional benefits based on volume of transactions or such metrics as stipulated by the merchant (e.g., number of visits, amount of purchase). The present invention will identify such syndicates and determine if a subscriber qualifies for admission and advance an ability to join, if the subscriber has not already joined and provided such membership information. As transactions are planned or occur, the merchant will have the option to connect to the subscriber's account, or vice versa. On connection, the present invention will provide a review and coordination, as applicable, of the syndicate additional benefits and initiate, request, apply, or record such benefits.

Dynamic Assurance, as following defined, may be employed to amend the one or more affected subscriber's account entries. In similar fashion, a subscriber using the present invention to engage in a transaction with a merchant that offers such syndicate program will have the present invention identify the subscriber's membership and query the merchant's membership operation to determine if there are additional benefits that may be applied to a transaction. If there are additional benefits to be applied and employed by the subscriber, coordination between the merchant's syndicate membership benefits and the subscriber's account will be adjusted upon a completed transaction. A further example is a health insurance group plan that provides discounts on various items.

Another feature of the present invention is the capability of an assurance provider to offer an incentive-based transaction with performance-based benefits. As an example, an environmental organization (e.g., Sierra Club) offers a new member enrollment transaction with an assurance component of a $2.00 payment for every kilowatt of reduced monthly electricity consumption by a residential household compared to their monthly electricity usage of one year ago. A subscriber may query the present invention and discover this Sierra Club transaction and enroll in the membership program. When initially entered in the subscriber's account, there is no payment of $2.00. What there is, is a commitment between Sierra Club and the subscriber for future action based on a described event (i.e., comparison of monthly electricity consumption readings) that will activate the present invention processing of conditions (i.e., compare this month this year to this month last year reading), with the transmission of processed information to Sierra Club (i.e., 5 kilowatts less use), and the reception of Sierra Club's acknowledgement and payment of $10.00 (e.g., digital currency payment) to the subscriber's designated account.

In this Sierra Club situation, an IoT electric meter allows the homeowner to direct the metrics to the present invention. The electricity metrics will be reviewed and processing operations determine if the assurance benefit of a $2.00 payment per reduced kilowatt is satisfied. If satisfied, the present invention calculates the incentive payment amount and transmits, with suitable credentials (e.g., meter reading, payment account), the result to the Sierra Club processing operation. On approval, the present invention receives and records the funds into a subscriber's designated account.

Actionable transactions are one component of the present invention in coordination with transforming combinable options into an integrated and aligned assurance manifest that provides assurance policy continuity and benefits beyond the prior art. The effect of this innovation is to enable a beneficiary to know and employ the full effect of assurances. The present invention addresses these aspects and others in a new and novel manner to educate, arrange, record, and inform users of improved options and available resources that enhance assurance opportunities. Data is transformed using analysis and prescriptive patterns to produce solutions for the benefit of the user.

The methods described herein provide assurance chaining that improves the prior art since, although the claims address a consumer challenge (i.e., integrating assurance provisions) it is a challenge particular to assurance terms involved in a transaction. The claimed solution is necessarily rooted in computer technology in order to overcome a problem specifically arising in the realm of transactions and assurances. The present invention provides improvement to the integration, combination, and use of assurances, and not simply tracking conventional terms (e.g., expiration dates) by well-known practices. The methods recite a specific, discrete implementation of the abstract idea of assurance chaining.

Tracking warranty expiration dates was already a known concept, and the present invention describes how its particular arrangement of assurance elements is a technical improvement over prior art ways of organizing such content. It is the incorporation of the described rules that improve the existing technological process by allowing the automation of further tasks as represented in FIG. 23. By incorporating the specific features of the methods, automatic processes provide assurance chaining using particular information and novel techniques. The present invention improves the operation of computer assurance management systems with its unique and novel assurance chaining.

The chaining of assurances provides enhancement, extension, or continuity of combinable warranty terms and assignments from the same or distinct assurance providers. The present invention improves the operation of assurances by identifying components that may be integrated, combined, or extended and thus provide consolidated holistic benefits to the user. As example, a continuous warranty structure is created by combining a manufacturer 2 year warranty with a 2 year extension from a credit card warranty provision.

As a further example, other than time related, a user will achieve an extended warranty structure by chaining distinct provider assurance terms such as a Milwaukee drill 2 year manufacturer repair warranty chained with a liability coverage payout from a Phillips electrical surge protector assurance of a $50,000 connected equipment policy. These are two distinct manufacturers offering two separate warranties (i.e., time and dollars) that can be integrated for the benefit of the user. The chaining of assurances also provides for the succession of ownership or benefits by arranging parties (e.g., beneficiaries) in a particular sequence, for example, the manner in which bequests of an estate may devolve to subsequent entities should an initial entity meet with demise. The prior art provides no such assimilation.

### Glossary

Assurance: Any of warranties, promises, guarantees, pledges, contracts, commitments, policies, reservations, performance, statements, vows, binders, warrants, duties, charges, allegiances, responsibilities, bequests, gifts or such other obligation as to commit one or more entity to deliver one or more item or perform one or more activity to another one or more entity.

Assurance Element: An individual object that includes one or more features, attributes, or specifications. For example and not limitation: an Assurance Policy; Uniform Product Code; Store Keeping Unit; Deed book and page; description; manufacturer; title number; vehicle ID number; product serial number; airline or cruise ship reservation code; color; weight; dimensions; and other details as may be appropriate according to the nature of the object or deemed acceptable by the entities involved.

Assurance Policy: The terms of performance designated by a Provider and conferred to a Subscriber or Beneficiary in operation with Transaction Masters and Assurance Elements that includes one or more features, attributes, or specifications. For example and not limitation, a Provider may offer terms including: refund, exchange, return, and gift options; duration of policy terms in whole or in part; conditions whereby the policy terms will be honored, disputed, or revoked; arbitration; jurisdiction; fees and charges; exchanges; contract identification; warranty terms and duration; process for claims; complementary and complimentary items; conditions and limitations; entity contact information; and other details as may be appropriate to a Transaction Master or Assurance Element. An Assurance Policy may be proffered or encumbered before, during, or after a transaction and involve Dynamic Assurance.

Beneficiary: As a person, group, organization, or a legal, virtual, or contrived entity, or a Subscriber may create and maintain an account in an assurance server configured to receive: identification; traits; transaction or communication information; Transaction Master; Assurance Element; feedback; Provider, Host, Subscriber information; and, any assigned assurance information related to the Beneficiary. The Beneficiary has standing and right to claim the performance of an Assurance Policy. The Beneficiary may have the right to transfer an assigned Assurance Element, and any related Assurance Element in a Transaction Master, to one or more Subscriber or Beneficiary if the Transaction Master and Assurance Element so permit such transfer. Such transfer being effectuated by such means as, for example and not limitation, sale, return, exchange, barter, gift, or donation as agreed to by the Beneficiary and transferee.

As a broad view of a Beneficiary, such is a person, group, organization, or entity that has standing to receive benefits, profits, or advantages and is the advocate of rights, claims, duties, and able to assert, demand, and obtain any of a right, title, possession, service, or other benefit. A Beneficiary may also act as a Subscriber and a Provider, and more than one Beneficiary may be assigned to a Transaction Master.

An example of Transaction Master sharing by two Beneficiaries, not as limitation, is a rental lease between a landlord and two individual lessees. The Transaction Master will have its Assurance Element assigned to both lessees as Beneficiary, each lessee having equal rights and responsibilities according to the Transaction Master. If the rental lease provides a sub-lease option, then the two individual lessees may reassign their Transaction Master Assurance Element to another lessee(s), all as recorded and managed by the present invention. This example demonstrates the use of both the sharing and the continuity aspects of an assigned Assurance Element.

An analysis of the Beneficiary is performed by the assurance management system using historical and current data sources to provide statistical, probability, and projection assessments of the Beneficiary.

Dynamic Assurance: The process of adjusting an established Assurance Policy or Assurance Element. As example, a manufacturer (i.e., Provider) may grant a universal Assurance Policy on a tool for two years of free repairs. Yet, having detected an anomaly in the tool design, tools with serial number xxx1 to xx99 will have the Assurance Policy extended by one year to three year free repair duration. Another example would be the identification of a Subscriber belonging to a particular group (e.g., member of a club or organization) with such membership being conferred additional benefits in addition to the universal Assurance Policy (e.g., a discount or rebate). While Assurance Policies are static in nature, Dynamic Assurance allows for amendments to Assurance Policy or Assurance Element as prompted by the Provider or requested by the Beneficiary, such as paying a fee to extend the original warranty duration within a set period of time after a purchase, to be updated and recorded in a Subscriber's account.

ERC-20: A token standard for a fungible token as they have a property that makes each token to be exactly the same (in type and value) of another token. It provides functionalities such as transferring tokens from one account to another, getting the current token balance of an account and also the total supply of the token available on the network. Compatible standards and systems are envisioned to be employed.

ERC-721: A free, open standard that describes how to build non-fungible or unique tokens on the Ethereum distributed ledger blockchain. While most tokens are fungible (every token is the same as every other token), ERC-721 tokens are all unique. Compatible standards and systems are envisioned to be employed.

ERC-998: Is an extension to the ERC-721 standard that adds the ability for non-fungible tokens to own other non-fungible tokens and ERC-20 tokens. Compatible standards and systems are envisioned to be employed.

Host: As a person, group, organization, or human, legal, virtual, or contrived entity, acting as a third-party intermediary, as example and not as limitation, a website, merchant site, or any purveyor presence, that may be employed by a Provider to display or make available an Assurance Element and construct a Transaction Master. A Host may combine a Transaction Master with terms, policies, guarantees, restrictions, conditions, requirements, effective time periods, and other Assurance Element and supplementary declarations in conjunction with a Provider's Assurance Element.

As example and not as limitation, an initiating Provider of an Assurance Element proffers a deliverable item, such as a microwave oven, and provides a commitment assurance to a buyer of defect-free operation for a time period of 1 year from the purchase date. The initiating Provider chooses to enlist the service of a hosting merchant, e.g., Walmart, to display the microwave oven and associated Assurance Element to the public. Walmart, as the Host, supplements the initiating Provider's Assurance Element with a further Host Transaction Master of assurance terms and, in particular, one assurance term which grants the buyer (i.e., Subscriber) of a right to receive a refund or exchange of the item within thirty days of acquiring the item along with the initiating Provider's Assurance Element. Any such Host-extended Transaction Master assurance operates in addition to the initiating Provider's Assurance Element, or may be subordinate to or supersede the initiating Provider's Assurance Element.

An analysis of the Host is performed by the assurance management system using historical and current data sources to provide statistical, probability, and projection assessments of the Host. The present invention may function as a Host.

Performance Factors: Performance rating factors are computed and produced for association with the information of all parties to a transaction or communication. The analysis and construction of performance and fidelity rating factors encompasses ratings, rankings, and projections that produce indicators of, as examples, confidence in what Providers exhibited and delivered in Transaction Masters, accuracy, and faithfulness of duty to assurance adherence by a Subscriber to commitment assurance terms. The fidelity factors integrate relevant historical and current feedback from users and computational elements of parties, weighted results of users providing feedback, transaction or communication information, and Transaction Master and Assurance Element terms that were claimed and advanced for fulfillment by a Subscriber and, as example and not as limitation: assurance terms that were fulfilled by the Provider of a Transaction Master or Assurance Element; assurance terms that were partially, conditionally, or failed to be fulfilled; and, assurance terms that were fulfilled within and outside the timeframe periods or environmental conditions such as when due/promised and when fulfilled/accomplished.

Performance factors may be computed by the assurance management system using historical and current data sources to provide statistical, probability, and projection assessments of the Providers, Subscribers, Beneficiaries, Hosts, and Assurance Elements. The ratings, rankings, probabilities, projections, and factors produced by the present invention analysis modules will be captured, stored, managed, maintained, used, and delivered in the course of system and methods operations. Data connections may be established to integrate external information of various parties including, without limitation, such items as odds-makers, user feedback scores from data sources (e.g., eBay, Facebook), or published and available data.

Ratings, rankings, and projections can use “weighting” factors in the production of ratings, rankings, and projections based on the ratings, rankings, probabilities, projections, and other reliability factors of a party entering the feedback information. An example, not as limitation, of a weighted-rating factor would involve the condition whereby a negative rating of a past time (e.g., more than a year ago) will have less significance than a positive rating of a current time (e.g., a week ago).

Privacy Features: Records are created in the present invention and allow classifying such records as public or private, or by formulating a hybrid format of public and private record classification by means of allocating certain record information as public or private, and further delineate whether records and information are accessible by all users or entities, or restricted to certain users and entities.

Provider: An entity originating an Assurance Policy or Assurance Element. The Provider may be composed of one or more parties or entities. (Reference Transaction Master and Transaction Supplement.)

A Provider, as a person, group, organization, or human, legal, virtual, or contrived entity, may optionally create and maintain an account in an assurance server configured to receive, as example and not limitation: identification; traits; deliverable item; Transaction Master; Assurance Element; transaction or communication information; assurance assignments; feedback; and, user information as may occur in a transaction or communication.

Subscriber: As a person, group, organization, or human, legal, virtual, or contrived entity, will create and maintain an account in an assurance server configured to receive, as example and not limitation: identification; traits; deliverable item; Transaction Master; Assurance Element; transaction or communication information; assurance assignments; feedback; Host, Provider, and Beneficiary information as may occur in a transaction or communication. A Subscriber has standing to receive benefits, profits, or advantages and is the advocate of rights, claims, and duties, and able to assert, demand, and obtain any of a right, title, possession, service, or other benefit.

A user that establishes an account with the present invention in accordance with its terms, policies, and requirements becomes authorized to use the system capabilities and features. An account owner may include other non-subscribed entities that are associates or referenced in transactions (e.g., a gift recipient as Beneficiary) and provide authorization for such one or more entity to act within the account as a pseudo-Subscriber. It is also envisioned that the general populace, as non-subscribed users, and external systems will have access and interaction with various features of the present invention. A Subscriber may also serve as a Provider and Beneficiary.

As example and not as limitation, the one or more advantages that a Subscriber obtains from a Transaction Master may include tangible and intangible proceeds, such as goods and services, as well as immaterial proceeds, such as fulfillment and satisfaction of an emotional, social, or personal nature.

A Subscriber may broadcast a request for a specific Transaction Master with Assurance Element (i.e., open bid). An analysis of the Subscriber may be performed by the assurance management system using historical and current data sources to provide statistical, probability, and projection assessments of the Subscriber.

Tokenization: The process of converting data into a fungible or non-fungible encoded structure (token) and stored in a verifiable arrangement as developed in such compatible distributed ledger blockchain technologies. The operations, processing, and logic of said tokenization will be readily apparent to those skilled in the art of computer programming, distributed-ledger technologies, and database management programming.

Transaction Master: A transaction envelope, or wrapper, in any form to be appropriately recorded in the assurance server being instantiated by one or more Provider and that includes one or more Assurance Policy or one or more Assurance Element. As example and not limitation, consider a purchase of a Milwaukee drill, a Makita saw, and DeWalt drill bits (i.e., Assurance Elements) from Home Depot. The printed sales receipt is the Transaction Master and operates as a wrapper for the Assurance Elements by listing the drill, saw, and bits on individual lines of text. Home Depot, as the Provider, offers an Assurance Policy of return/refund terms while Milwaukee, Makita, and DeWalt provide their own Assurance Policy for manufacturer warranty repairs. As further example, an e-mail receipt from Home Depot for the same transaction would have the e-mail message as the Transaction Master wrapper with the Assurance Element details listed within the content of the message.

A Subscriber can induct or create and maintain a Transaction Master record comprised of Assurance Element in an assurance server configured to receive identification, traits, deliverable item, functional terms, policies, pledges, guarantees, events, statements, restrictions, conditions, effective time periods, environmental conditions, feedback, Host, Beneficiary, and other information as used in a transaction, or as transmitted from a client device to the present invention. A Transaction Master may be created by user input or external to the present invention service in various forms and formats, and then inducted by a Subscriber or transmitted by a Provider into the present invention by automatic or manual means.

Deliverable item(s), as example and not limitation, being product, service, concept, undertaking, event, statement, contract, pledge, promise, gift, succession, or action, is related to an assurance of terms, policies, guarantees, restrictions, conditions, effective time periods, promises, environmental factors, and other information to produce a structure combining the deliverable item(s) and the assurance term(s), such combined structure being referred to as a Transaction Master, which is then constructed, promulgated, and proffered or delivered to one or more Subscriber.

A Transaction Master may contain embedded monitors, actions, orders, commands, or processing instructions that may be executed by one or more distributed-ledger server storing a Transaction Master, or by the present invention service provider at the occurrence of a specific time(s), event(s), or other causality operation(s) so as to request, initiate, modify, continue, complete, or rescind any of terms, policies, conditions, effective time periods, Host, Provider, Subscriber, Beneficiary, and any of the declarations as may be detailed in the Transaction Master.

A Transaction Master may have one or more elements, terms, or provisions, for example: promised by date, schedule of performance times, commencement date and time of Assurance Element, termination date and time of Beneficiary or of any assigned Assurance Element, transferability conditions, benefits, liabilities, limitations, participants, digital artifacts, events, event horizons, locations, requirements, and such other features as may be incorporated by a Subscriber which encompass committable items, preferences, and circumstances as deemed appropriate or necessary to a transaction or communication. A Transaction Master may have additional attachments such as, without limitation, digital information, links, images, recordings, or documents.

A Transaction Master may be created, shared, delivered, exchanged, transferred, negotiated, amended, transmitted, or communicated asynchronously or interactively using suitable means in any manner with a person, group, organization, or human, legal, virtual, or contrived entity; or, a Transaction Master or Transaction Element may be created, shared, delivered, exchanged, transmitted, negotiated, amended, or provided for exhibition or delivery asynchronously or interactively using suitable means by an intermediary Host using, as example and not limitation, a website, merchant site, or any transmitter presence.

A Transaction Master may be exhibited and employed asynchronously or interactively using a format including, but not limited to, a human and/or machine-readable text display attached to a container or displayed or transmitted by any methodology, encoded in any optical medium, encoded in any radio frequency medium, any audio format for human or device consumption, any visual format for human or device consumption, any form of analog or digital encoding, Internet Uniform Resource Locator, and any means of device for person-to-person, machine-to-person, person-to-machine, or system-to-system communication.

A Transaction Master as created, proffered, and employed by the one or more Subscriber, or accessed by a Subscriber, may consist of internal records and information as stored within the present invention, records and information as stored in an external data storage system of any media configuration that provides the present invention with access to the information, or any combination of internal and external sources of information of any media configuration that provides the present invention with access to the Transaction Master information.

A Transaction Master optionally includes smart contract features that include embedded processing instructions and connections with monitors, referred to by skilled practitioners in the art as distributed-ledger technology, or blockchain smart contract, and as monitored by an Oracle, which automatically trigger automated commands and actions. The reference to “smart contract” includes assurance terms of a transaction or communication which are placed into computer code, which resides on a server computing device. A feature of a smart contract is that it runs autonomously; when the assurance terms of a transaction or communication are monitored and determined to be applicable, the code executes and fulfills the processing instruction constructs. Products can be turned into services and availed of using smart contracts.

The operations, processing, and logic of smart contract provisions will be readily apparent to those skilled in the art of computer programming, distributed-ledger technologies, and database management systems. A distributed-ledger blockchain system may serve as a Host. A Transaction Master may be transmitted to one or more distributed-ledger systems for current or delayed use, archival purposes, on-going transactions or communications, or as a template for actions.

Transaction Master Analysis: An analysis of the Provider and Transaction Master may be performed by the assurance management system using historical and current internal or external data sources to provide statistical factors, ratings, projections, and probability assessments of the Provider and one or more Assurance Element. Data connections may be established to integrate external information of parties including, without limitation, such items as odds-makers, Subscriber feedback scores from review sources (e.g., eBay, Facebook), and available or public data.

Transaction Supplement: One or more accompanying Providers associated with a Transaction Master and offering an Assurance Policy. Such supplementary Provider may be equal with or subordinate to a primary Provider with respect to performance of an Assurance Policy. As example and not limitation, a used car purchase from a dealer may have the dealership grant a 30 day return Assurance Policy and include an extended CarShield repair Assurance Policy when paid with cash. The purchase agreement is the Transaction Master with the dealer as primary Provider, CarShield as a supplementary Provider, and the automobile as the Assurance Element. Using the example within the Transaction Master glossary definition, Home Depot is the Provider of a refund assurance while Milwaukee is a Transaction Supplement offering a warranty repair assurance.

Transaction Review: A transaction or communication review of a proffered or delivered item or service and related Transaction Master may include the use of statistical analysis, probabilities, projections, inference, machine intelligence, assisted learning, linear and non-linear analysis models, and algorithms of computational means employing internal and external sources of information and data in a review to produce data and information to a Subscriber that would be advantageous and useful in the selection of an item or service, Transaction Master, Provider or Host or Beneficiary selection, and the means by which such item or service and related Transaction Master may be best aligned and associated with a Subscriber. This will be determined by providing ratings and recommendations during or after a review of the item or service and related Transaction Master by considering features, failures, longevity, durability, quality, alternates, feedback, alternative combinable features, and Provider characteristics of an historical and current nature of the item or service and related Provider Transaction Master.

Transaction Value Settlement: A method of value exchange involved with a transaction. The value method and associated details, including any related Assurance Policy, would be incorporated with the Transaction Master as a Transaction Supplement. As example and not limitation, a purchase at Home Depot paid for by using a MasterCard credit card (e.g., Transaction Supplement). Such payment information would be embedded with the Transaction Master as well as MasterCard's Assurance Policy.

A settlement is that which is considered by a Provider as compensation or acceptance consent in order to provide, deliver, connect, or conclude a transfer of a Transaction Master to a Subscriber, and for a Subscriber to accept and acquire the Transaction Master. As example and not limitation, a settlement could be the provision of products, currencies, services (e.g., dog walking), postage stamps, Transaction Master, Acme rocket sleds, agreement, utterance of “Okay” using audio or text, or such settlement form as a Provider accepts as value, adoption, connection, or consent.

### Overview

An assurance is an encumbrance on a Provider to deliver a service, action, or item to a Subscriber/Beneficiary with the terms manifested in an Assurance Policy. For example, when purchasing a Milwaukee M18 drill from Home Depot, the merchant is encumbered to provide a refund or exchange to the consumer, if so requested, according to the store's merchandise policy. With respect to this invention's specification and conventions, this purchase transaction has Home Depot as the Provider of an Assurance Policy with refund/exchange terms, and the drill as an Assurance Element with an Assurance Policy, all of which are assigned to the consumer as Subscriber/Beneficiary. Home Depot and the drill are not the only actors in this transaction and additional parties need to be considered for assurance integration.

Along with Home Depot and a drill in this example transaction there is the Transaction Value (e.g., MasterCard payment), a discount coupon (e.g., coupon issued by RetailMeNot.com), the manufacturer of the drill (e.g., Milwaukee's repair warranty), and a manufacturer's rebate offer. These additional parties each offer their own assurances that may combine with or extend related assurances.

A further examination of the above Home Depot transaction and its components will reveal prior art deficiencies in various assurance aspects. As example and not limitation, all individual assurance terms fail to be announced to the consumer and integrated into a holistic manner for continuity and presentation and thus diminish the Subscriber's ability to know the full value of their benefits. For example, Home Depot will provide their return/refund policy timeline on their receipts, but Milwaukee's warranty and MasterCard's extension of the manufacturer warranty are not provided. The present invention addresses these deficiency aspects with methods to identify, integrate, transform, authenticate, and provide new and novel means of informing and providing value to a Subscriber.

Further details of the example Home Depot transaction, using present specification conventions, describe: Home Depot (i.e., primary Provider) and its Assurance Policy (e.g., refund or exchange); the Milwaukee M18 drill (i.e., Assurance Element); Milwaukee (i.e., Transaction Supplement) and its Assurance Policy; and, MasterCard's Assurance Policy (i.e., Transaction Supplement and Value). Further parties to the transaction include: RetailMeNot.com's Assurance Policy (i.e., Transaction Supplement) for a discount with respect to both the merchant and consumer; and, a Milwaukee rebate offer (i.e., Assurance Policy). All parties being required to fulfill their merchant and consumer commitments (e.g., MasterCard payment settlement to primary Provider and extension of a manufacturer warranty to Subscriber). The present invention provides means for the Subscriber/Beneficiary to manage with knowledge, ease, and fidelity the one or more applicable Assurance Policy or option in the transaction.

A typical consumer sees this transaction as simply “buying a drill at Home Depot and walking out with it” and not understanding the integrative nature of these additional parties' assurance features. Little, if any, knowledge or regard may be afforded to the “fine print” of the combined and valuable options to which they have the right to claim. Being uninformed of the total value of benefits fails to provide value or advantage to the consumer.

Another feature provided by the present invention is a method of connecting a Transaction Master's one or more Assurance Element to another Assurance Element whether contained in the same or external Transaction Master. As an example and not limitation, a Phillips electrical surge protector includes “a limited-lifetime no-hassle replacement plan” and a supplementary assurance of “a $50,000 connected equipment policy.” The present invention allows a Subscriber to connect one or more of their Assurance Element (e.g., desktop computer, microwave oven) to the Phillips Assurance Element, or vice-versa, to integrate extended warranty coverage that can exceed a manufacturer's limited repair time warranty.

As example, the use of Dynamic Assurance allows the Phillips Assurance Policy of the $50,000 coverage term to be connected to a desktop computer Assurance Element. The desktop computer Assurance Policy, and its related Transaction Master terms, may be amended with the Phillips Assurance Policy. With the ability of connecting the computer to the $50,000 coverage, a Subscriber would be able to claim benefit, in the event of damage, that could be in excess of any stated manufacturer assurance time or value limitation. A Phillips electrical surge protector liability warranty provides for devices that may be attached to it, but not on a permanent basis. For example, a fan is plugged in to the surge protector during the summer, and in the winter an electric heater is connected. Dynamic Assurance provides for the re-assignment of such mobile Assurance Policies. The prior art has no such feature for assurance mobility options.

### Outline of Operation

A user creates a Subscriber account with details of, as example and not limitation, name, contact information, and such other personal and commercial details as requested by the system design and interface. On completion of a created and accepted account, a Subscriber is able to access the various features of the present invention, such as having access to query, record and manage information, perform analysis, transmit and receive information and notifications.

In coordination with a potential or actual transaction, a collection of Assurance Policy terms from Providers are accessible by query, or by being negotiated among the participants of a transaction, prior to, during, or in dynamic fashion after a transaction. For example, a Subscriber has the ability to query the present invention with a tentative transaction topic (e.g., merchant return policy, Milwaukee M18 drill warranty), or to solicit other Subscribers into forming a cohort with the purpose of petitioning Providers for enhanced Assurance Policy terms for a particular item or service. A query may also seek to identify the most favorable one or more Assurance Policy for an Assurance Element (e.g., Milwaukee M18 drill) as achieved by another Subscriber.

With respect to a concluded transaction, one or more of the transaction parties transmits the details of the transaction to the present invention by means of manual, optical, or electronic means. As example and not limitation, a purchase at Home Depot could provide the Subscriber with the option to have a digital sales receipt e-mailed, or data transmitted by other electronic means (e.g., radio frequencies), to the invention's data service system. Another example of data entry allows a printed sales receipt to be optically scanned, parsed, and transmitted by appropriate means to the data service system. A further example of data entry provides a Subscriber the ability to manually enter the sales receipt information into an Internet browser-based or standalone software application. Other options for data transmission and reception are considered as developments occur and as one skilled in the art could provide.

On receiving the sales receipt data, the present invention begins the construction of a Transaction Master record that is suitable for adaptation to the Ethereum ERC-998 protocol, or compatible, for production of a token. A review for parsing Assurance Policy integration terms may occur at this stage or at other stages of operation.

Transaction Supplements, as may be present, are parsed and records constructed that are suitable for adaptation to the Ethereum ERC-20 or ERC-721 protocols, or compatible, as appropriate according to the nature of the Transaction Supplement, for production of one or more tokens as appropriate. A review for parsing Assurance Policy integration terms may occur at this stage or at other stages of operation.

Continuing the processing methods, the one or more Assurance Elements are parsed and records are constructed that are suitable for adaptation to the Ethereum ERC-20 or ERC-721 protocols, or compatible, as appropriate according to the nature of the Assurance Element and operating standards, for production of one or more tokens. A review for Assurance Policy integration terms may occur at this stage or at other stages of operation.

The amalgamation of Transaction Master, Transaction Supplement, and Assurance Element tokens are then transformed into an authenticated, verifiable, non-fungible token to represent the holistic transaction with continuity and availability of complementary option terms (i.e., Dynamic Assurance).

Processing methods continue with an analysis and compilation of the transaction data. Each Provider's Assurance Policy, as assigned to the Transaction Master, and each Assurance Element in the Transaction Master, is parsed and reviewed for integration or combination with any one or more Transaction Supplement's Assurance Policy. As example and not limitation, a purchase using the MasterCard credit card provides for an extension of a manufacturer's warranty. MasterCard policy doubles an eligible item's original warranty for a maximum of 24 months. This invention will determine if the Assurance Element qualifies for the MasterCard warranty extension and if so, will combine with and adjust the manufacturer's expiration date accordingly.

Further processing may determine that a third party (i.e., Transaction Supplement) warranty service was contained in the Transaction Master. Such third party warranty will be parsed, reviewed, and adjust by extension or exclusion the appropriate warranty details (e.g., increased mileage allowance), based on any manufacturer, payment, and third party coverages. Such review, integration, combination, exclusion, transformation, and notification is not available in the prior art while the innovative features in the present specification address these and other deficiencies.

Continuing the processing, methods determine available and applicable Transaction Supplements (e.g., manufacturer rebate, purchase of an after-transaction warranty extension) external to the Transaction Master that can be applied to the Transaction Master by use of Dynamic Assurance. Any such identified Transaction Supplement will be notified to the Subscriber and should it be accepted, then it will be appropriately parsed, processed, recorded, and integrated with the Transaction Master with applicable combination and tokenization. All related records of the Transaction Master will be amended accordingly (e.g., rebate credit amount, warranty coverage period, extended warranty details). Dynamic Assurance not only allows for addition and modification of an Assurance Policy, but also for the deletion of Assurance Policy or terms. In addition, Assurance Elements may be transferred to a Beneficiary as allowed by the Assurance Policy and employ such Dynamic Assurance techniques.

Operations continue employing data science algorithms that engage in transforming the transaction data by, as example and not limitation: identifying and assembling cohorts; providing artificial intelligence analysis of ease and fidelity regarding performance of Providers, Subscribers, and Assurance Policies; determining or negotiating Assurance Policy terms for past, present, or future transactions; identifying new or amended opportunities for Subscriber enhancements; and, such other algorithmic features as would be available to one skilled in the art of pattern analysis and probability performance. These and other features are made available by the present invention and are beyond the scope of the prior art.

Processing methods continue operating on the Transaction Master records to identify similar and related Assurance Elements that will form the construction of cohorts. As example and not limitation, a Subscriber considering the purchase of a Milwaukee M18 drill may solicit to assemble a cohort of similarly interested or existing owner Subscribers. Subscribers joining the cohort will provide authorization to be included in a class action petition for adjustments to the standard Milwaukee Assurance Policy (e.g., extended coverage). The petition will be advanced to the Provider. If changes to the standard Assurance Policy are delivered by the Provider, the cohort will be notified of such amendments and request their acceptance or rejection. On amendment acceptance, a Transaction Master with applicable amendments will be instantiate for new purchases or Dynamic Assurance will adjust existing Assurance Policy records.

The processing continues with results of operations tokenized and committed to a distributed ledgers and database structures as will be known to one skilled in the art of database management, and account data provided to Subscribers and parties (e.g., Beneficiary, authorized clients) in a user interface commensurate with available display means (e.g., smartphone browser, software application, audio). The display interface to include any of charts, graphs, ratings, text, audio, video, barcodes, tags, beacons, or such components as would be known to one skilled in the art of data conveyance.

Additional processing allows for the reputation of the Assurance Element, along with the fidelity of the Provider and Subscriber, to be analyzed and ranked in terms of many factors, some of which include: a party's accuracy, reliability and performance factors; assurance category rating; ranking of time frame or environmental factor in which an assurance is valid compared to similar items or services; and, probability of Assurance Element performance versus time, environmental conditions, structure, number of claims, or activity.

In order to improve the utility of various transaction, communication, and assurance information, the present invention transforms one or more portions of such information into a different state of trustworthy, reliability, comparative, and projection ratings by using data processing analysis, comparison, feedback, inference, trend and pattern recognition, and machine learning expert modules to evaluate terms and parties involved in assurances and assignments, and to produce ratings, rankings, and projections. It is also another feature of the present invention to provide for one or more segments of the Transaction Master and related Assurance Element to be verified and constructed into a token (e.g., distributed ledger blockchain technology) so as to provide authentication for the purpose of conferring the Subscriber with proof and presentation of their right to claim assurance performance and assist with such claim.

The present invention service being configured with network, communication, transmission, recording, processing, analysis, methods, and storage means that allow for the reception, broadcast, operation, and retention of data. An account will be identified by one or more schemes including, as example and not as limitation, a name, account code, pseudonym, biometric feature, electronic feature, avatar, social media identification, public or private marking, analog identifier, digital identifier, optical identifier, radio frequency identifier, spectrum identifier, automaton or machine characteristic, or algorithmic construct.

### DESCRIPTION OF PRIOR ART

There are assurances in many transactions, agreements, promises, and communications, ranging from public and private dealings to disclosed and anonymous exchanges that occur every day. An assurance may be comprised of one or more functional terms, such as a refund policy, a payment due date, transferability, warranty of a tool, and survivability terms or an action to be performed.

An assurance is always directed to benefit a person or entity, yet the beneficiary may not know or be informed of the available assurance terms (e.g., a gift recipient). To address such deficiencies, the present invention organizes and manages the assignment, analysis, ratings, combination, notification, maintenance, and authentication of assurances for the advantage of the beneficiary. While prior art systems monitor warranties, there is no prior art that comprehensively facilitates, coordinates, analyzes, integrates, combines, notifies, and monitors assurances, along with the various parties, in a holistic and continuous manner.

As an example, a person could produce a painting, either physical or digital, and offer it for sale. A Subscriber of the arts notices the painting and decides to buy it in a transaction. The buyer is given an assurance policy from the seller that the buyer will obtain clear title to the painting. The seller may provide further assurance terms to the buyer in addition to the transfer of title, such as: the painting may be returned for a refund within 7 days; that the paint, assuming a physical object, will not peel or crack for the lifetime of the painting otherwise repairs will be made free of charge; or, that any future sale of the painting will remunerate the original seller with a commission. The buyer now has these additional assurance terms of a refund and lifetime repairs to complement the assurance term of ownership. There is also an obligation on the buyer to provide a future commission payment on a resale (e.g., reverse obligation assurance term). The buyer indicates that they may want to give the painting as a gift, and the seller agrees that if that occurs, then the gift recipient would be entitled to the same assurance terms and duties, and such transferability will be incorporated with the other assurance terms.

In this painting transaction, the buyer is initially assigned as the beneficiary of these assurance terms when the painting is purchased. If the buyer decides to give the painting as a gift to a friend, then that friend becomes the new assigned beneficiary and, as such, is entitled to all the assurance terms that the seller provided to the buyer, including any survivable reverse obligations. The prior art offers conventional methods of paper documents or digital receipts, yet the original purchaser may not provide the gift recipient with all documents. Furthermore, a gift recipient may not forward the documents to another recipient, and then the original assurances and duties are lost with the passage of time and a trail of ownership among multiple recipients. The present invention provides the means to capture, record, research, analyze, track, transfer, combine, manage, authenticate, tokenize, and notify parties of established assurance terms in a new and novel transformational manner. The present invention also produces information for the utility of the beneficiary to understand aspects, such as the reliability factor of the seller, which will help to guide them in their selections, actions, expectations, and decisions. In addition, the authentication aspect will provide a means to submit proof of the seller's Assurance Policy and right to claim performance.

To extend the painting example, should a gift recipient beneficiary make a claim for assurance term performance (e.g., repairs), eventual feedback on the seller's performance can be submitted. Such feedback, and the present invention's analysis factors, may adjust the seller's account ratings which then are used by others in their research and decision activities. Prior art does not address the assignments, analysis, management, feedback, ratings, notifications, and authentication as described in the present specification.

A significant deficiency of prior art is that the beneficiary (e.g., gift recipient) may not be informed of the Assurance Policy assignments in which they are involved; the assurance terms that are provided and assigned to them; the times or events of assurance coverage; reverse obligations; the ability to provide feedback; authentication of activity; or, the ratings of the parties they have dealings with. There is prior art that informs a buyer of a warranty expiration date, but such systems are deficient in features such as, for example, registering the assigned beneficiary and the one or more assurance terms they are entitled to claim; providing performance factors and ratings of direct and analysis means; authentication; and, holistically managing and notifying parties of related assignments, performance, and ratings information.

The specification of U.S. Pat. No. 8,229,861 discloses methods of “determining . . . warranties associated with the purchased item”, “determining . . . durations for each of the warranties associated with the purchased item”, and “determining . . . warranty active or inactive status for each of the warranties associated with the purchased item”. This prior art is focused on items and is strictly associated with durations for each of the singular warranty dates and does not implement warranty combinations. In contrast, the present invention adds useful transformative combinations and analysis features as well as managing the myriad feature assurance terms and environmental factors (e.g., button clicks, torque load) that are conditioned in an assurance, along with the status and ratings of the parties with respect to fidelity.

Prior art determinations of strict warranty time attributes does not take into account instances of assurance assignments with open time periods or other environmental conditions (e.g., torque load). Examples of items that do not fall within the framework of such prior art systems are appointments and reservations. An appointment does not have an expiration time, but it does have an engagement time with an assurance of performance by, for example, a specialist such as a specific hair stylist. The same applies to a reservation for dinner at a restaurant. There is a reservation engagement time, but not a warranty expiration time (e.g., a person can stay at a dinner table all night long). Should the Subscriber not be available at the time of the appointment or reservation, by using the present invention the Subscriber would be able to assign another person as the Beneficiary of the appointment or reservation assurance (i.e., transferable, survivable). Prior art systems do not describe such flexible assurance terms, transfer situations, or the notification of assurance transfers.

A further example of a non-time attribute situation is a warranty that covers a number of power cycles. A switch may be warranted to perform a power cycle for one hundred times with any problem occurring before that numeric limit being granted a free repair or replacement by the manufacturer. In this example, the assurance policy may last for 1 day or 10 years depending on when the switch is used.

It is well noted that people are included in and granted many assurances, either of their choosing or as a subordinate, with or without their knowledge. Life insurance policies, wills, donations, lottery tickets, patents, promises, IOUs, as well as purchases of product and service items as gifts are but a few instances of assurance assignments to subordinate parties. Managing and monitoring all such assurances with their multitude of commitments, statements, features, time periods, activity limitations, reverse obligations, events, requirements, default conditions, actions, activation obligations, as well as maintaining a list of contacts, sellers, intermediaries, buyers and all of the various terms, ratings, conditions, and policies that each party may be involved with, and maintained up-to-date, is a complex task of reconciliation beyond human capability and in need of a novel means of coordination.

The present invention manages the roles of the Subscribers, Providers and Beneficiary as to how assurances apply to them individually and in concert with each other. There are many assurances and conditions of a transaction, communication, or statement, including assurance terms and actions, which may be promulgated by a Provider to a Beneficiary, and equally, conditions that a Beneficiary may promulgate to a Provider. As presented in the current specification, this present assurance management system and methods will provide heretofore unavailable integrative utility and rating features for managing, researching, reviewing, and authenticating assurances.

The invention of a comprehensive source of assurances, ratings, combinations, and authentication will simplify and enhance all parties' ability to track, review, analyze, manage, research, monitor, be informed, produce, and assert their rights, privileges, and authority to claim, or amend the assurances to which they are entitled as well as to be better informed of the parties they deal with. A novel benefit of the present invention is to incentivize compliance and performance of an assurance by making assurances persistent and enabling ratings of an assurance (i.e. atomistic), and not merely a rating of the Provider in general or other parties involved in an assurance, to be available for review.

Further benefits of the embodiments of the present specification include, but are not limited to: a Beneficiary assignment service for entering transaction or communication information as well as transfers and notifications; easy access to Assurance Element terms and related environmental factors, action dates and events, compliance and default action notifications, ratings, projections and probability factors, and such other assurance features that are unavailable, unknown, or ignored by a Subscriber; an improved means to organize assurances; notification capabilities for assurances that require actions or are subject to actions within specified limits or events; and, authentication as to prevent loss of rights due to absent documentation or lack of notification. In the event that a Subscriber needs to demand rights to an assigned assurance term, the Subscriber can access their account on the assurance management system server and retrieve their assigned Assurance Element information for validation and guidance. Further benefits include, without limitation: Provider assurances, statements, and postings will be compiled with ratings with regard to accuracy, fidelity, reliability, and performance fulfillment. Similar compilations for Assurance Elements, Beneficiary activities, and associated parties as may be involved are also performed.

It will be appreciated that variations of the disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the methods and claims. The claims can encompass embodiments in hardware, software, or combinations thereof.

### EMBODIMENTS

Embodiments of the system and methods are provided as examples of an assurance management construct. The Subscriber and Beneficiary records comprise descriptive information and system connections associated with one or more Transaction Master as provided by one or more Provider record comprising descriptive information and system connections.

One or more of machine-readable Transaction Master records being assigned to one or more machine-readable Subscriber or Beneficiary account records, with such Transaction Master record comprised of one or more Assurance Element, and such Assurance Element referring to one or more Assurance Policy, and such Subscriber or Beneficiary assignment of a Transaction Master being collective or atomistic to the assurance terms.

Where such one or more Transaction Master is created and proffered by one or more Provider, with such one or more human or machine-readable Transaction Master being exhibited, negotiated, transferred, or communicated by the Provider using analog or digital communication methodologies or by use of one or more searchable human or machine-readable Hosts, to one or more Subscriber. During such display, exhibition, communication, negotiation, transfer, delivery, or acceptance, a Subscriber or Beneficiary may be provisionally or factually assigned to a Transaction Master.

Wherein the Transaction Master Assurance Element are described by entries made by the one or more Provider or optionally with one or more Host or optionally with one or more Subscriber, and such Assurance Element is recorded and transmitted by the one or more Provider or the one or more Host to the Subscriber on a Subscriber agreeing to acquire the one or more Transaction Master by completing a transaction.

As example and not limitation, a customer at Home Depot with several items to be purchased (i.e., Assurance Elements) will enter their MasterCard credit card as payment and a checkout touchscreen will request Subscriber payment approval (Yes/No to the amount). Such approval of payment will create a Transaction Master and bind the Home Depot refund/exchange policy, and the other Assurance Element policies, to the Subscriber who is also the pro tem Beneficiary. An e-receipt could be transmitted to the present invention, or to a customer's e-mail address, for entry as a digitally encoded Transaction Master. Optionally, the Transaction Master with Assurance Elements is printed in paper form for manual entry into this invention.

One or more processors, and one or more memories as adapted to store a plurality of machine-readable instructions which when executed by the one or more processors are adapted to cause the system to provide: assignment, analysis, authentication, encryption, tokenization, notification, storage, and management operations all as configured to process Transaction Master and Assurance Element information; produce analysis, rating, and projection results of parties, Transaction Master, and Assurance Element; record available and related transaction assurance information, ratings, rankings, and projections; creation, authentication, and transfer of various token protocol objects; and, assignment of records to the applicable Subscriber, Beneficiary, Provider, Host, or Transaction Master as involved in the operations of the present invention.

Information related to a transaction, Transaction Master, Provider, or Host, Subscriber, and Beneficiary may be appropriately integrated, configured, combined, analyzed, and compiled by the present invention using methods that allow for the transmission, processing, encryption, tokenization, display, notification, and storage of such compiled information into one or more distributed-ledger system server of a public, private, or hybrid nature, and such compiled information made available for access by authorized parties as will be apparent to those skilled in the art of computer programming, distributed-ledger technologies, and database management.

To wit, this invention, in a novel and unobvious manner, provides Subscriber and Beneficiary assignments, analysis, transformative states, and management of Transaction Masters to produce ratings and rankings and projections, coordinate Subscriber and Beneficiary and Provider rights, duties, requirements, and commitments by using assignable and combinable assurance terms, action dates, objects, metrics, and events in a new and innovative way. The invention: captures; records; organizes; analyzes; rates; manages; combines; tokenizes; monitors; signals; and, notifies episodes of assurance conditions as well as Subscriber and Beneficiary and Provider ratings and projection factors and assignments. Such notifications include without limitation assignment status, standing of any assignments, actions to be performed, action dates, time periods, environmental conditions, events, metrics, or combinations thereof.

The present invention resolves various transaction deficiencies by transforming a “Blind Beneficiary” into an “Assurance Advocate” by means of a central Subscriber and Beneficiary repository to record, organize, manage, combine, monitor, and notify assurance assignments as contained in Transaction Masters. The present invention's integration and combination of the “fine print” details of one or more Provider Assurance Policy will transform the isolated components into a coherent combination producing a different and innovative state solution. As example, MasterCard will extend a manufacturer's time period warranty, yet many MasterCard cardholders do not read the extensive legal documents and thus are unaware of such benefit and do not apprise themselves of the benefit or they fail to connect it to a purchased item. Such lost value is a detriment to the Subscriber or Beneficiary and a deficiency of the prior art. In addition, as example, Providers may offer rebates which require after-purchase actions which the Subscriber is unaware of, or lacks documentation, and leads to further forfeited benefit.

As example and not limitation, by using the present invention a Subscriber that purchases a gift with a defect repair warranty may list the recipient of the gift as Beneficiary in a Transaction Master for defect assurance claims, but not for a payment refund. Prior art does not coordinate and enable the dual status of only allowing the original purchaser (i.e., Subscriber) to be entitled to a payment refund, while allowing the gift recipient (i.e., Beneficiary) the right to claim defect repairs without involvement of the Subscriber. The present invention allows an Assurance Element to be transferred, along with its Assurance Policy, to a Beneficiary exclusive of other rights and privileges.

The present invention notifies the gift recipient of their Beneficiary status as subscribed in a Transaction Master and provides an appropriate non-fungible token for the gift recipient to use should the need arise to claim defect repairs, but not necessarily enable a payment refund. Gift giving (e.g., holidays, anniversary occasions) abounds with many items purchased for later distribution such that warranty credentials may not accompany the gift. As an example, prior art attempts to remedy this situation by creating gift cards that attempt to correct this duality failure of credential provisioning by placing the original purchase in the hands of the gift recipient with all assurances accruing to their direct use. While convenient, a gift card removes the intangible satisfaction of providing a thoughtful or surprising gift with enduring remembrance. The prior art duality deficiency is one example of how the present invention provides a novel and innovative approach to assurance management and improvement.

The present invention operates based on storing, organizing, analyzing, rating, managing, monitoring, combining, transforming, and tokenizing the one or more Assurance Element residing in a Transaction Master along with the Transaction Master. Such Assurance Element as promulgated by a Provider and incorporated in a Transaction Master, and the Transaction Master being obtained by a Subscriber in a transaction or communication, transfer, or acceptance, and having the one or more Assurance Element assigned to a Subscriber or Beneficiary. Transaction Masters and Assurance Elements, in whole or in part, may be assigned to one or more Subscriber or Beneficiary, and notification provided to applicable parties of the Subscriber and Beneficiary assignment as being integrated with, accepted as, contracted to, and notified of the assignment of the Transaction Master's one or more Assurance Element.

The present invention provides the means and capability to integrate and synchronize all of the involved data sources and databases in order to allow the present invention to bring a unified experience to the user. The operation of this novel system is innovative, wide-ranging, and a unique enhancement exceeding prior art.

### DESCRIPTION OF THE DRAWINGS

These and other advantages will become more apparent from the detailed description of the various embodiments of the present specification with reference to the drawings wherein:

FIG. 1 is a block diagram of an assurance management system, in accordance with the embodiments of the present specification that illustrates establishing and executing data connections, communication, display, delivery, processing, transactions, settlements, analysis, combinations, encryption, ratings, assignment, tokenization, monitoring, and storage functions.

FIG. 2 illustrates a screen display of information related to a Provider account in accordance with the embodiments of the present disclosure.

FIG. 3 illustrates a screen display of information related to a Host account in accordance with the embodiments of the present disclosure.

FIG. 4 illustrates a screen display of information related to a Subscriber account in accordance with the embodiments of the present disclosure.

FIG. 5 illustrates a screen display of information related to a Beneficiary account in accordance with the embodiments of the present disclosure.

FIG. 6 illustrates a screen display of information related to a Transaction Master framework in accordance with the embodiments of the present disclosure.

FIG. 7 illustrates a screen display of information related to a transaction in accordance with the embodiments of the present disclosure.

FIG. 8 illustrates a screen display of information related to an assignment of a Beneficiary in accordance with the embodiments of the present disclosure.

FIG. 9A is a block diagram of an assurance management server processing system that illustrates a flow-diagram of the present invention.

FIG. 9B depicts further steps carried out by the process started in FIG. 9A.

FIG. 10 illustrates a screen display of information related to a Transaction Master communication framework in accordance with the embodiments of the present disclosure.

FIG. 11 is a block diagram of a flow chart displaying the processing of a Provider creating and transmitting a Transaction Master.

FIG. 12 is a block diagram of a flow chart displaying the processing of a Beneficiary receiving a Transaction Master.

FIG. 13 illustrates a screen display of information related to the analysis of a Transaction Master.

FIG. 14 illustrates a screen display of information related to the entry of rating and feedback information from Subscriber to Provider.

FIG. 15 is a block diagram of a flow chart displaying the processing of a Beneficiary providing rating and feedback to a Provider.

FIG. 16 illustrates a screen display of information related to the entry of rating and feedback information from Provider to Subscriber.

FIG. 17 is a block diagram of a flow chart displaying the processing of a Provider providing rating and feedback to Beneficiary.

FIG. 18 illustrates a screen display of information related to a listing of Transaction Masters.

FIG. 19 illustrates a screen display of information related to a Provider listing of reliability ratings for Transaction Masters.

FIG. 20 illustrates a screen display of information related to the entry of rating and feedback information for a selected account.

FIG. 21 is a block diagram of a flow chart displaying the processing of a Subscriber providing rating and feedback to a selected account.

FIG. 22 is a stacked Venn diagram illustrating the conceptual arrangement of processing components.

FIG. 23 illustrates an example of a product purchase flow-diagram with transformed integrated and combined assurance policies.

FIG. 24 illustrates a visual display of the one or more assurance metric aspects as combined and monitored.

### DETAILED DESCRIPTION AND MODE OF IMPLEMENTATION

The present system and methods provide means to manage in a convenient and combinatorial manner transactions related to one or more Provider and Assurance Element and construct a registry of agreements, assignments, assurance terms, combinations, tokens, ratings, projections, and feedback for Subscribers.

Subscribers and Beneficiaries can be associated with any type of transaction, communication, or assigned instrument including, but not limited to, association or group instances including assurance terms and any one or more of grants that bestow, confer, contract with, present title or rights, declare requirements, make available, or convey an assignment to a Subscriber or Beneficiary that assures and warrants the Subscriber or Beneficiary the ability to any of privileges or rights to assert, demand, obtain standing, gain possession, exercise, review, and invoke claim and entitlement to one or more assurance terms.

### DETAILED DESCRIPTION

The embodiments of the present specification pertain to an invention that is designed for individual, group, and entity users. The embodiments provide a system and methods for transactions and communications involving assurances to be recorded, processed, and reviewed, thus enabling methods of combination, authentication, preservation, analysis, and production of documentation and results. The Transaction Master and Assurance Element, along with their respective Assurance Policy, are the core functional components enabling assurance terms to be managed for the benefit of a Subscriber. No inferences should be drawn that the account structures (logically or physically) as described or displayed are intended to limit the structure that is implemented.

The assurance system processes and extracts data from a transaction or communication and creates a data record of the transaction or communication and performs operational assignments in various storage systems including distributed-ledger systems.

Access to the assurance service is accomplished through online hosted servers using application software that processes the transaction or communication information, extracts data, combines, authenticates and tokenizes data, and produces ratings and projections. Further embodiments of the present specification may be embedded in other applications, such as digital wallets and social media systems. Subscribers may pay a periodic fee to use the software application.

In the event that a Subscriber needs to generate a claim for assurance performance (e.g., free repair of a device), a Subscriber can access their account on the system server and retrieve information such as their assigned rights of assurance performance, guarantees, time periods, obligations, and be able to present to the repairing authority authentic documentation (e.g., tokens) for confirmation of device purchase and ownership.

At various times, the Subscriber is notified and informed of their assurance rights still in force and advised of such assurance terms as being available and actively conferred to the Subscriber. The service can also provide lists of transaction parties as originally involved in the assignment of any Transaction Master or Assurance Element. Consequently, the present invention combines a number of electronic and digital capabilities to make Subscriber assignment and assurance management more convenient, accurate, efficient, trustworthy, and persistent. These features and aspects will become better understood with regard to the following descriptions of the embodiments.

The following presents the general operation of the present invention with processing features that may be accomplished by a person skilled in the art of data communication, computer programming, databases, encryption, distributed ledgers, and related system infrastructures.

A Provider optionally connects to the present invention system server using a device with communication and data network means and creates a Provider account record in a connected database. The Provider database record comprises data fields such as, for example and not limitation, name, identification code(s), contact information, default settlement options, default assurance terms and policies, premiums, operating conditions, environmental metrics, and public and private encryption codes.

A Provider account record is not required for a Provider to have a Transaction Master received by a Subscriber account and entered into the present invention. A Transaction Master can be created external to the present invention service in various forms and formats and designations, and then received by a Subscriber and entered into the assurance service server by automatic or manual means on the selection, reception, connection, or acquisition of a Transaction Master (e.g., purchase of a product at a retail outlet and the manual entry of the merchant's printed sales receipt data).

To create or enter a Transaction Master or Assurance Element, a Provider having an account record will connect to the present invention service server using a device with communication and data network means to create or enter one or more Transaction Master or Assurance Element record in a connected database. The Transaction Master or Assurance Element database record comprises one or more of data fields such as, for example and not limitation, Provider identification, contact information, statement, category, item description, item identification, Assurance Policy with assurance terms, conditions, valid dates and times when the Transaction Master or Assurance Element in whole and/or individual assurance terms in part may be active, environmental metrics, settlement or acceptance options, and ratings. Once constructed, the Transaction Master or Assurance Element may be transmitted, using appropriate means, to a Provider, Host, or Subscriber.

An Assurance Policy in a Transaction Master or Assurance Element may include provision of actionable items or services, as example and not limitation, advantages, awards, benefits, claims, contracts, dates, disbursements, donations, duties, valid time periods, events, features, items, pledges, powers, prizes, privileges, profits, promises, receipts, reimbursements, repairs, replacements, reservations, rights, services, titles, vows, winnings, in any single or combination thereof.

An example of an Assurance Policy is a home insurance policy that pledges to pay $250,000.00 upon certain damage conditions occurring. Another example of an Assurance Policy is a theatre guaranteeing the reservation of a specific seat at a concert. A further example of an Assurance Policy is a lawn maintenance service promising to cut a homeowner's lawn bi-weekly. In all instances, the present invention service processes and extracts data from transaction or communication information and creates a data record of the transaction or communication, parses the assurance provisions, combines available features, enters Transaction Master and Assurance Element records, and performs Subscriber assignments in various storage systems as described in this specification.

A Provider having created, transmitted, or entered a Transaction Master or Assurance Element may then exhibit or deliver it, with collateral materials as appropriate, by using one or more display or transmission channels. The Transaction Master or Assurance Element could be exhibited, as example, by use of a direct communication channel (e.g., e-Mail, telemarketing), or by a public display channel (e.g., placement of a product on a Walmart store shelf, Internet website), or combinations of display channels. The use of an intermediary by the Provider to exhibit a Transaction Master to prospective Subscribers, such as exhibiting a product on a Walmart shelf, constitutes the use of a Host (e.g., Walmart) and such Host may append their own supplementary Assurance Policy (i.e. Transaction Supplement) to the Provider's Transaction Master. As an example, Walmart may provide assurance terms of a refund or exchange within thirty days of purchase in addition to any Provider Assurance Policy, e.g., free defect repairs for one year. As an example, Milwaukee Tool Company, as a Provider, creates an Assurance Element record in their account for an M18 drill. Milwaukee then contracts with Walmart, as Host, to display their M18 drill on the store shelf. Walmart sells the drill to a consumer (i.e., Subscriber) with Walmart creating a Transaction Master and including Milwaukee's Assurance Element in the sales receipt.

Information related to the Provider Transaction Master will be presented in a fashion appropriate for the particular display or communication channel. The present invention service will process and extract data from the transaction or communication information and create a data record of the transaction or communication and perform operational analysis, combinations, ratings, rankings, projections, and Subscriber assignments in various storage systems as described in this specification.

The Provider, Subscriber, and Host account interfaces and database would have multiple action options available as one skilled in the art of member account management would readily understand to provide, e.g., profile maintenance, data entry, feedback, search, and display.

The fields and columns not specifically mentioned in accounts, yet deemed appropriate as conditions evolve, will be readily apparent to those skilled in the art of user interface and database design and implementation. It should be understood that the field and column structure displayed in screen templates is merely representative and not intended to restrict the present invention. Those skilled in the art of database management system design and implementation may make changes, including the addition or deletion of fields to effectuate system functionality.

The user and system display configuration presented is simplified here for purposes of brevity. In actual implementations, many more fields may be used to facilitate other account data and related information and to incorporate additional system parameters related to the evolving nature of transactions and information. The display layouts will be readily appreciated by those skilled in the art of database management system design and implementation. It should be noted that the fields and their apparent arrangement in displays are merely representative to enable one skilled in the art to make and use the present invention. No inferences should be drawn that the account structures (logically or physically) as described or displayed are intended to limit the structure that is implemented.

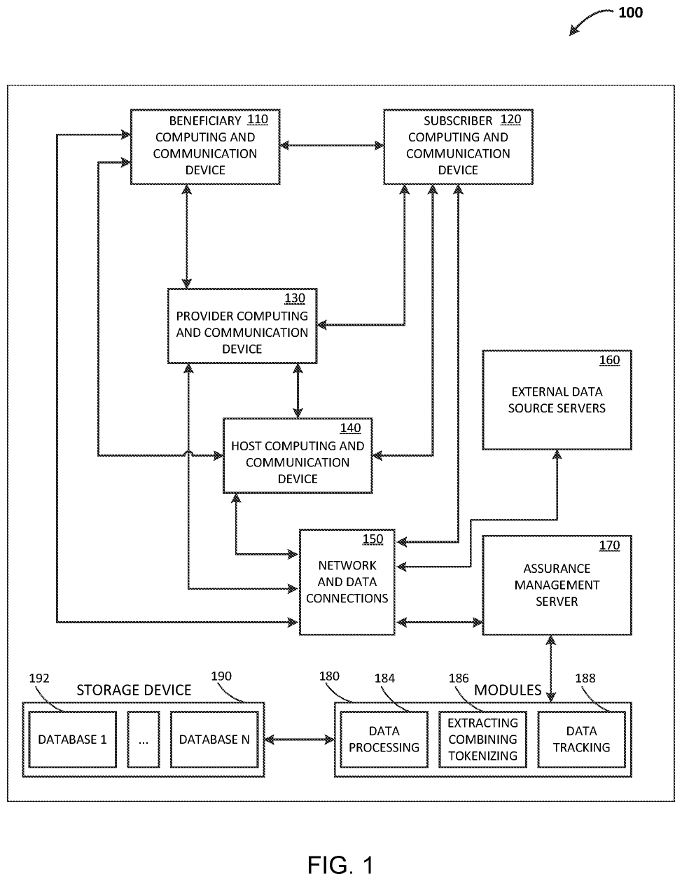

FIG. 1 illustrates an assurance management system in accordance with the embodiments of the present specification. The system 100 includes a Beneficiary computing and communication device 110, a Subscriber computing and communication device 120, a Provider computing and communication device 130, a Host computing and communication device 140, network and data connections 150, external data source servers 160, assurance management servers 170, one or more modules 180, a data processing module 184, a data extraction, combination, and tokenizing module 186, a data tracking module 188, a storage device 190, and one or more database 192.

The computing and communication devices 110, 120, 130, and 140 illustrate methods of inputting and receiving information for transmission using network and data connections 150 with server 170. Computing and communication devices would include, without limitation, mobile devices, telephones, beacons, tags, virtual assistants, and personal computers. It is contemplated that any type of computing and data communication device may be used for transmission and reception with the server 170.

The computing and communication devices 110, 120, 130, and 140 may communicate with server 170 through any transmission network 150 (e.g., Internet, telephone) having operative communication and data transfer connections.

The server 170 is a server for performing services for connected clients. The server 170 is in operative communication with the one or more modules 180. In the embodiments of the present disclosure there are three modules. These include the data processing module 184, the data extraction, combination, and tokenizing module 186, and the data tracking module 188. However, a number of other modules are contemplated to provide system services and capabilities as technologies evolve.

The data processing module 184 processes internal and external data received and transmitted through network connections 150. The data extraction module 186 is used for extracting specific processed data from the data processed by module 184. The data to be extracted and employed may be pre-programmed by software or may be manually performed by the Subscriber. The extracted data will be reviewed for combination of related assurance terms and compiled into tokens by module 186 as appropriate according to the present invention. The data tracking module 188 is used for tracking and monitoring the data processed by the data processing module 184, and the data extracted by the data extraction, combination, and tokenizing module 186. The data tracking module 188 tracks and monitors the processed and extracted data for review, changes, and notification purposes.

The data that is processed by the one or more modules 180 is stored in the storage device 190. The storage device 190 may contain one or more databases 192. The data stored in the database 192 can contain, without limitation, one or more of names and addresses, accounts, Transaction Master, Assurance Element, tokens, ratings, and item or service information.

In addition, information can be determined by the system employing available data, as example: Subscriber rating and projection factors integrating internal and external information such as social media. Furthermore, content management software or distributed ledger systems can be used to trigger events based on events or conditions. Such trigger allows Subscribers to be informed during predetermined or projected events or time periods that an Assurance Element requires action or is nearing an exceptional situation or conclusion of one or more assurance terms.

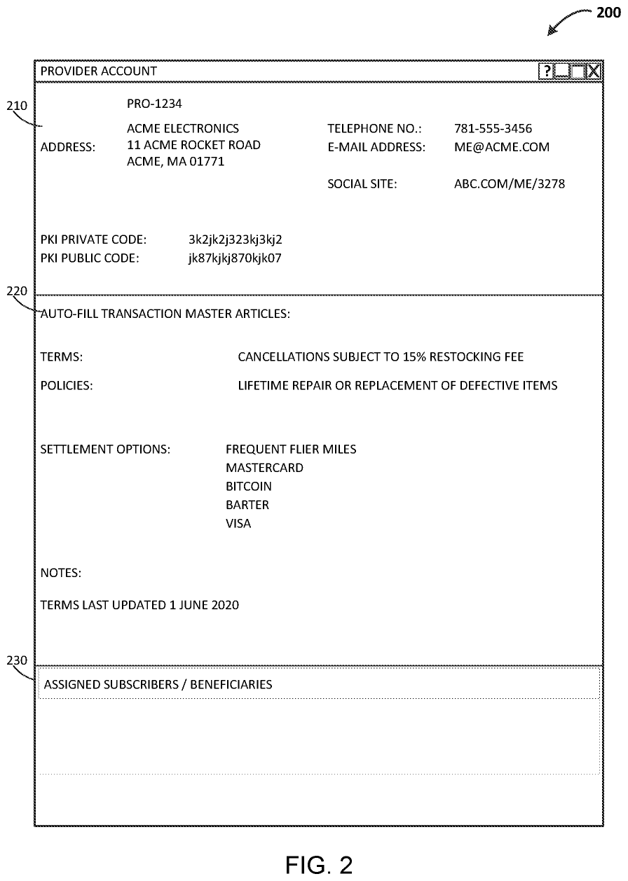

Referring now to FIG. 2, therein depicted is a Provider's information account record illustrated as a database computer system screen entry and display according to the present invention. In particular, screen 200 resembles a typical computer system screen display as a representation of details including, without limitation, personal information and ratings 210, preferences and policies, rules and conditions, settlement options, and notices 220, and assignments 230 data in the form of system information and correspondingly printed on screen 200 to indicate the guidelines of operation to be carried out or executed by assurance management server 170. Screen 200 is a visual display form that is generated in a conventional manner by or on behalf of assurance management server 170 and is usually presented via a computer display terminal or any such visual, audio, or tactile display device.

In all screen and visual display instances, the present invention certainly envisions Subscribers employing other means of entering and receiving information beyond visual displays, such as, without limitation, audio, system-to-system communications, tactile, along with robotic and evolving automaton means.

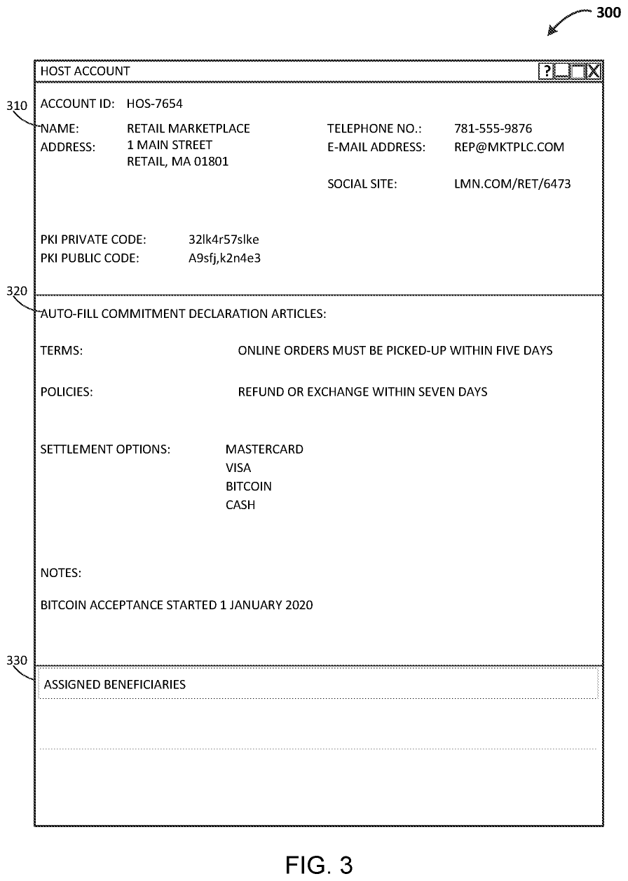

Referring now to FIG. 3, therein depicted is a Host's information account record illustrated as a database computer system screen entry and display according to the present invention. In particular, screen 300 resembles a typical computer system screen display as a representation of details including, without limitation, personal information and ratings 310, preferences and policies, rules and conditions, settlement options, and notices 320, and assignments 330 data in the form of system information and correspondingly printed on screen 300 to indicate the guidelines of operation to be carried out or executed by assurance management server 170. Screen 300 is a visual display form that is generated in a conventional way by or on behalf of assurance management server 170.

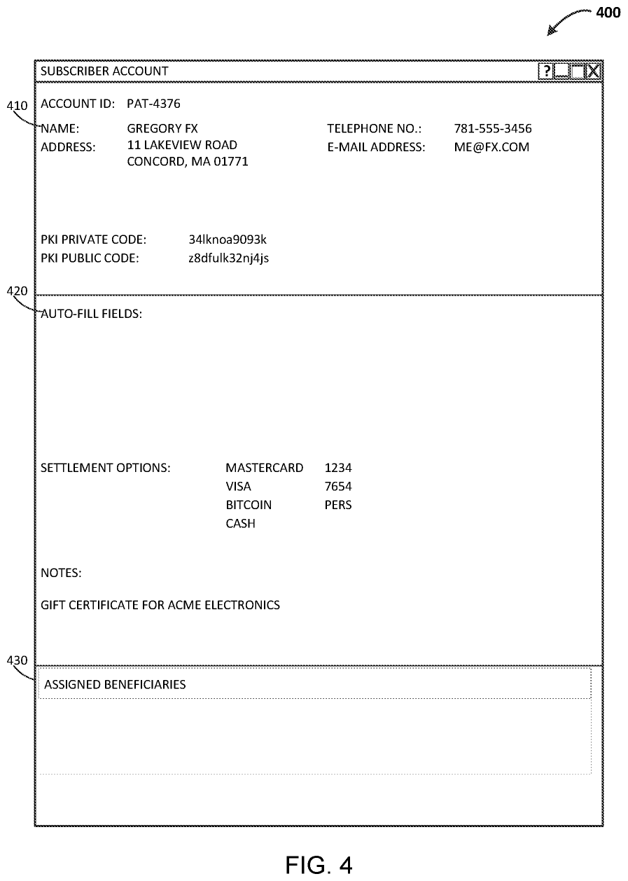

Referring to FIG. 4, therein depicted is a Subscriber's information account record illustrated as a database computer system screen entry and display according to the present invention. In particular, screen 400 resembles a typical computer system screen display as a representation of details including, without limitation, personal information and ratings 410, preferences and policies, rules and conditions, settlement options, and notices 420, and assignments 430 data in the form of system information and correspondingly printed on screen 400 to indicate the guidelines of operation to be carried out or executed by assurance management server 170. Screen 400 is a visual display form that is generated in a conventional way by or on behalf of assurance management server 170.

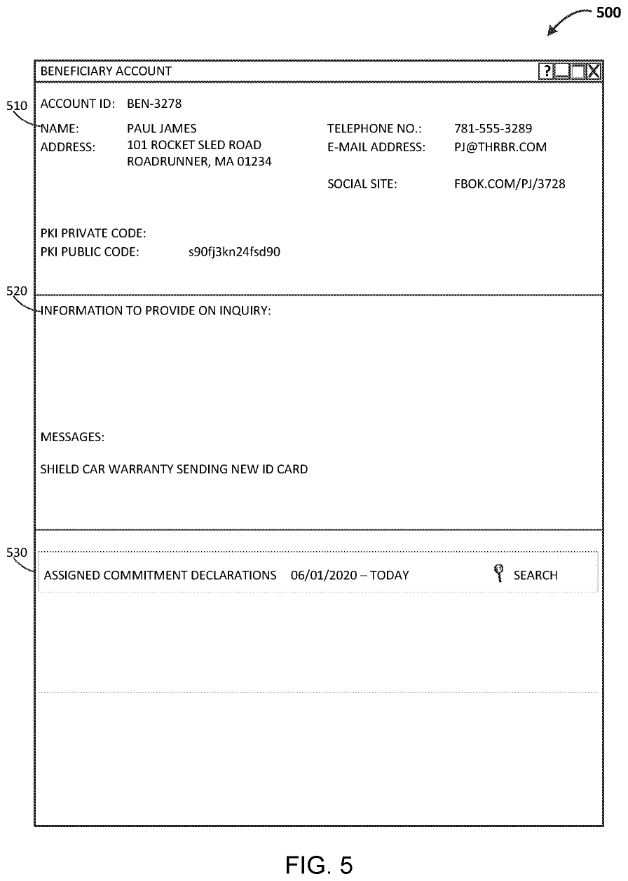

Referring now to FIG. 5, therein depicted is a Beneficiary's information account record illustrated as a database computer system screen entry and display according to the present invention. In particular, screen 500 resembles a typical computer system screen display as a representation of details including, without limitation, personal information and ratings 510, preferences and disclosures, rules and conditions, and messages 520, and assignments 530 data in the form of system information and correspondingly printed on screen 500 to indicate the guidelines of operation to be carried out or executed by assurance management server 170. Screen 500 is a visual display form that is generated in a conventional way by or on behalf of assurance management server 170.

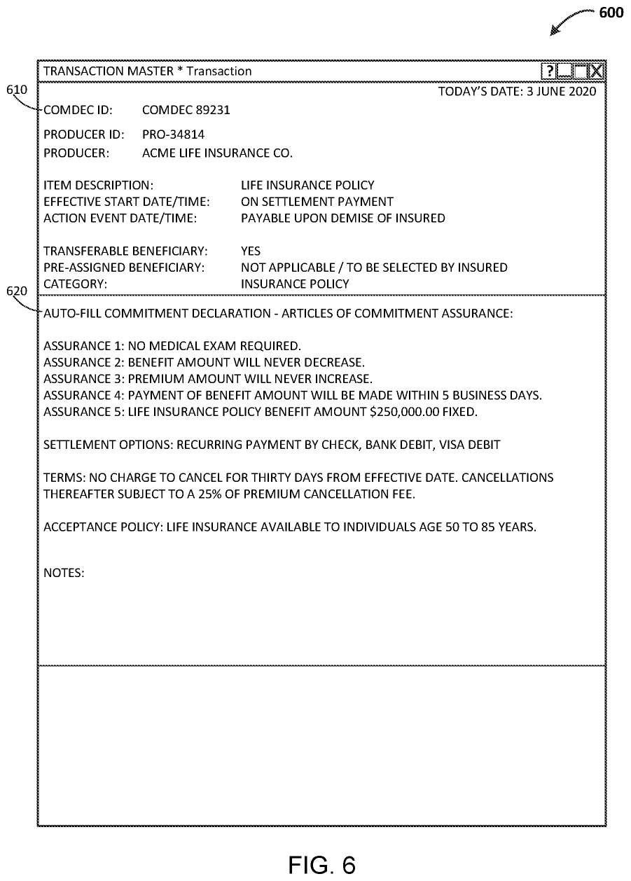

Referring to FIG. 6, therein depicted is a Transaction Master's transaction information account record illustrated as a database computer system screen entry and display according to the present invention. In particular, screen 600 resembles a typical computer system screen display as a representation of details including, without limitation, personal information and item description and Transaction Master and Assurance Element attributes 610, assurance terms, settlement acceptance options, rules and conditions, and notes and messages 620 data in the form of system information and correspondingly printed on screen 600 to indicate the guidelines of operation to be carried out or executed by assurance management server 170. Screen 600 is a visual display form that is generated in a conventional way by or on behalf of assurance management server 170.

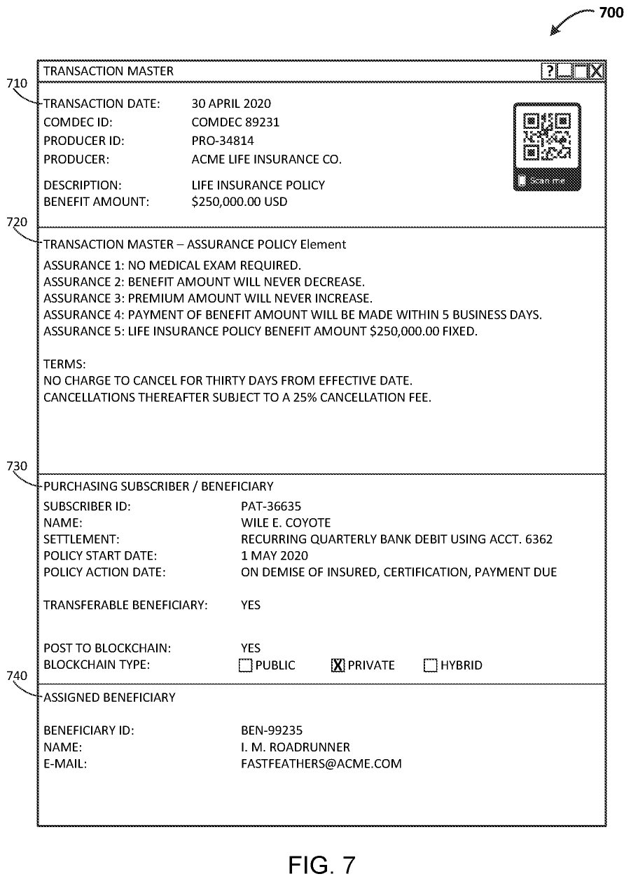

Referring now to FIG. 7, therein depicted is a transaction's information record as Transaction Master delivered to a Subscriber or Beneficiary illustrated as a database computer system screen entry and display according to the present invention. In particular, screen 700 resembles a typical computer system screen display as a representation of details including, without limitation, personal information and item description and attributes 710, assurance terms, settlement acceptance options, rules and conditions, and notes and messages 720, Subscriber information and transaction details and options 730, and Beneficiary information and details 740 data in the form of system information and correspondingly printed on screen 700 to indicate the guidelines of operation to be carried out or executed by assurance management server 170. Screen 700 is a visual display form that is generated in a conventional way by or on behalf of assurance management server 170.

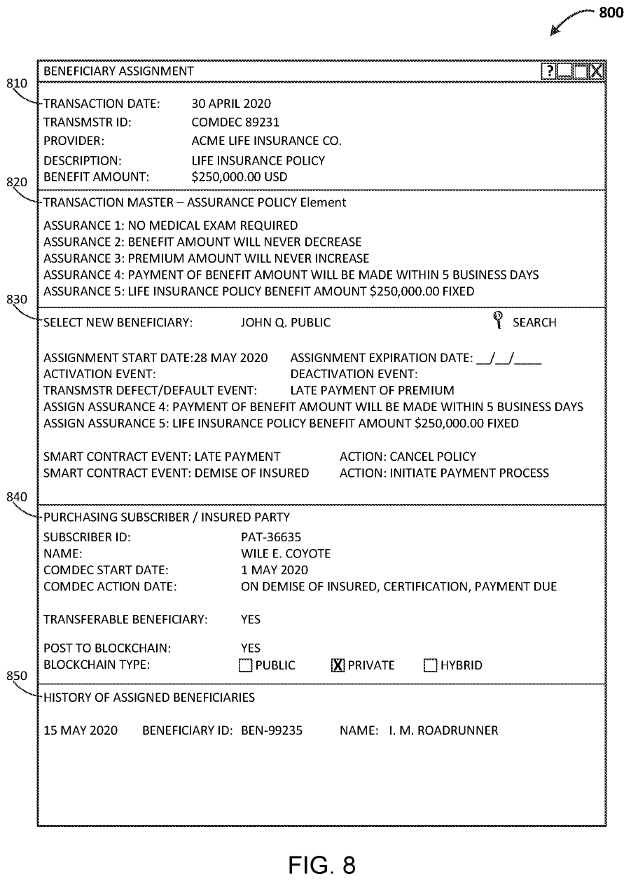

Referring to FIG. 8, therein depicted is a Beneficiary's assignment information record illustrated as a database computer system screen entry and display according to the present invention. In particular, screen 800 resembles a typical computer system screen display as a representation of details including, without limitation, personal information and Transaction Master and Assurance Element description and attributes 810, Transaction Master and Assurance Element assurance terms, rules and conditions, and notes and messages 820, selected Beneficiary information and assurance details and options 830, Subscriber information and Transaction Master description and options 840, and present and past history of assigned Beneficiary information and details 850 data in the form of system information and correspondingly printed on screen 800 to indicate the guidelines of operation to be carried out or executed by assurance management server 170. Screen 800 is a visual display form that is generated in a conventional way by or on behalf of assurance management server 170.

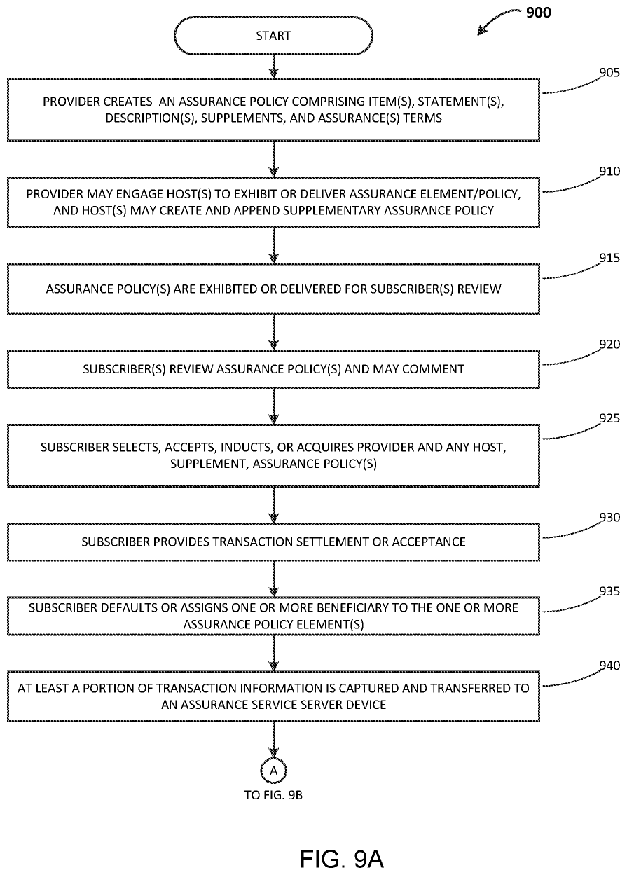

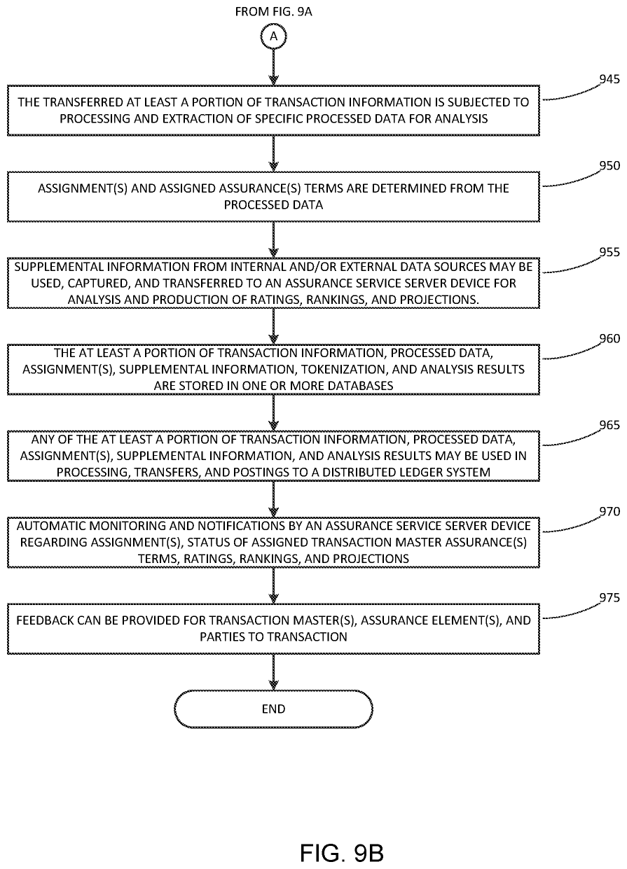

FIGS. 9A and 9B illustrate an assurance management flow-diagram in accordance with the embodiments of the present specification. The method 900 includes the following steps. In step 905, a Provider creates an Assurance Policy describing statements, items, assurance terms, and other declaratory information. In step 910, the Provider may use a Host to exhibit or deliver the Assurance Element Assurance Policy and a supplementary Assurance Policy may be created and appended by the Host. In step 915, the Assurance Policy(s) are exhibited or delivered to Subscriber. In step 920, Subscriber(s) are able to review Assurance Policy(s) and may provide comment. In step 925, a Subscriber can select, accept, enter, or acquire Assurance Policy(s). In step 930, a Subscriber provides settlement or acceptance. In step 935, Subscriber becomes default Beneficiary or makes a Beneficiary assignment(s) to the one or more Assurance Element(s). In step 940, one or more portions of the transaction information are transferred to an assurance service server device. In step 945, the transferred information is processed and data extracted for analysis and combination. In step 950, Subscriber assignments are determined from the processed data. In step 955, internal and external data may be used, captured, and transferred to the assurance service server device for analysis and production of ratings, rankings, and projections. In step 960, transaction information, processed data, assignment(s), supplemental information, tokenization, and the results of analysis and combinations are stored in one or more databases of a storage device. In step 965, transaction information, processed data, assignment(s), supplemental information, and the results of analysis and combination may be processed, transferred, and posted to a distributed ledger system. In step 970, Providers, Subscribers, Beneficiaries, and Transaction Master and Assurance Element terms, conditions, and ratings will be monitored and notifications sent to appropriate parties. In step 975, feedback can be provided regarding transaction, Transaction Masters, Assurance Elements, and parties to a transaction.

The flow-diagram described in FIGS. 9A and 9B allows a Subscriber to access data located in a server and stored in one or more databases in order to update, access, research, verify, and/or modify information, as performed by the Subscriber. In the embodiments, Subscribers may access other assurance management services offered by the present invention service. To wit, a Subscriber may have access to user-defined analytic tools for data analysis to complement the ratings, rankings, and projections produced by the assurance management service server. Additional functions that may be available to the Subscriber include: automatically being notified of Transaction Master amendments, track ratings against user-defined parameters, and asynchronously or interactively share feedback and messages regarding Providers, Subscribers, Beneficiaries, or events which may impact the performance or ratings of a Transaction Master, Assurance Element, or associated parties.

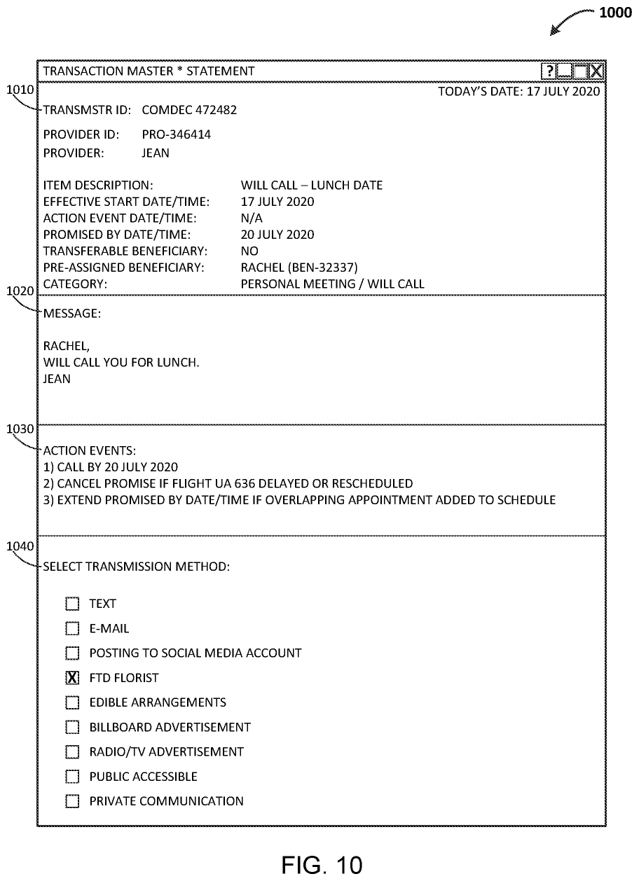

Referring now to FIG. 10, therein depicted is a Transaction Master's statement information account record illustrated as a database computer system screen entry and display according to the present invention. In particular, screen 1000 resembles a typical computer system screen display as a representation of details including, without limitation, personal information and item description and Transaction Master Assurance Element attributes 1010, statement of assurance terms, acceptance options, rules and conditions 1020, events and times of notifications 1030, methods of transmission and communication 1040 data in the form of system information and correspondingly printed on screen 1000 to indicate the guidelines of operation to be carried out or executed by assurance management server 170. Screen 1000 is a visual display form that is generated in a conventional way by or on behalf of assurance management server 170.

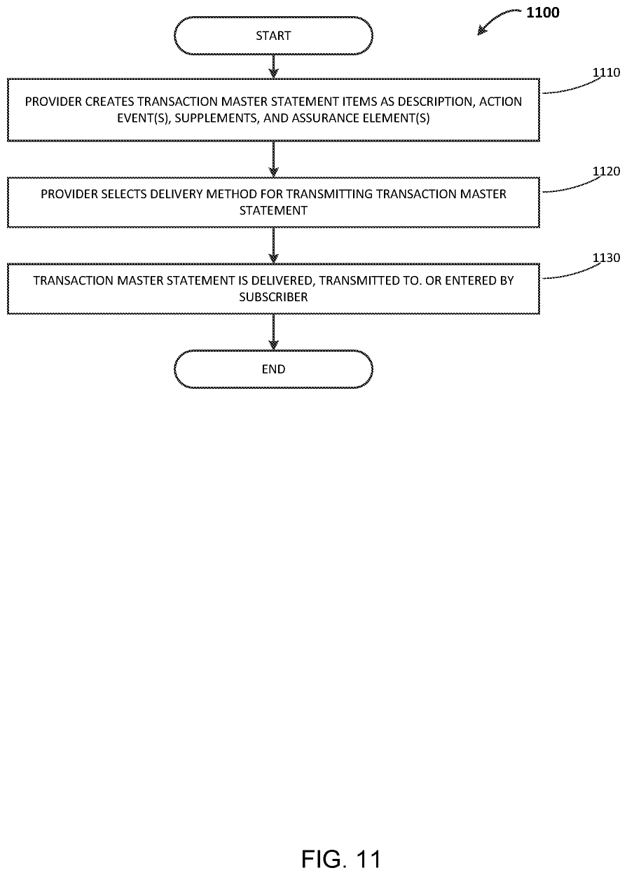

Referring to FIG. 11 therein illustrates an assurance management flow-diagram in accordance with the embodiments of the present specification. The method 1100 includes the following steps. In step 1110, a Provider creates a Transaction Master describing one or more of statements, items, Assurance Elements, and other declaratory information. In step 1120, the Provider may use one or more means of making the Transaction Master Assurance Element statement available for exhibition or delivery. In step 1130, the Transaction Master statement is transmitted to or entered by one or more Subscriber.

The flow-diagram described in FIG. 11 allows a Provider or Subscriber to access data located in a server and stored in one or more databases in order to create, update, access, receive, research, verify, or modify information, as performed by the Provider or Subscriber. Additional functions that may be available to the Provider and Subscriber include: automatically being notified of Transaction Master amendments, track ratings against user-defined parameters, and asynchronously or interactively sharing feedback and messages regarding the one or more Provider and Subscriber, or events which may impact the performance, fidelity, or ratings of a Transaction Master or associated parties.

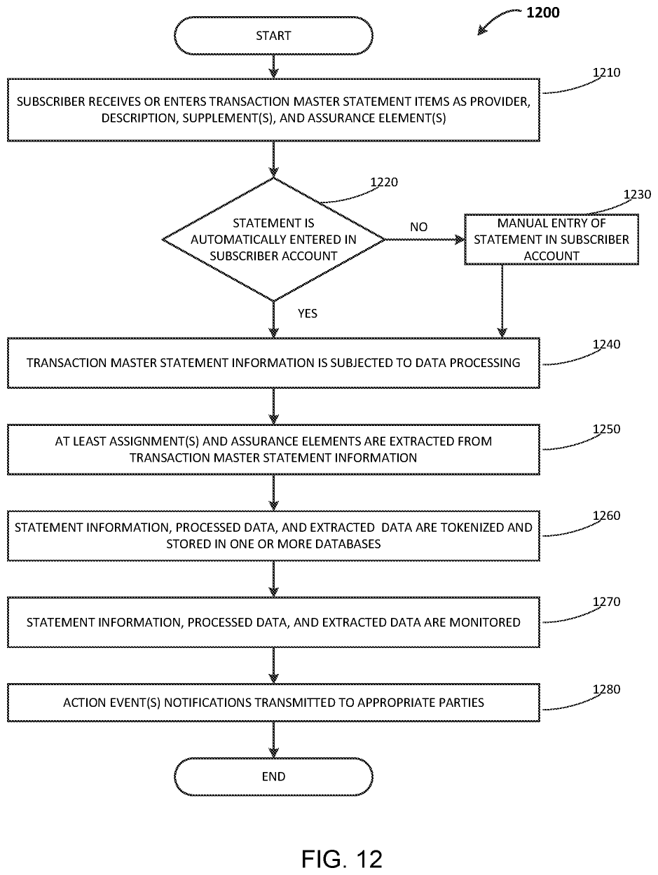

Referring now to FIG. 12 therein illustrates an assurance management Transaction Master processing flow-diagram in accordance with the embodiments of the present specification. The method 1200 includes the following steps. In step 1210, a Subscriber receives or enters a Transaction Master describing one or more statements, items, Assurance Element, Assurance Policy, and other declaratory information. In step 1220, the Transaction Master is automatically entered or manually entered 1230 in Subscriber account. In step 1240, Transaction Master data is processed in accordance with the embodiments of the present specification. In step 1250, extraction of statement information data is processed in accordance with the embodiments of the present specification. In step 1260, statement information, processed data, extracted data, assignment(s), supplemental information, and the results of analysis are combined, tokenized, and stored in one or more databases of a storage device 190. In step 1270, statement information, processed data, extracted data, combinations, assignment(s), supplemental information, and the results of analysis are monitored. In step 1280, process notifications are transmitted to appropriate parties.

The flow-diagram described in FIG. 12 allows a Subscriber to access data located in a server and stored in one or more databases in order to create, update, access, receive, research, verify, or modify information, as performed by the Subscriber. Additional functions may be available to the Subscriber in accordance with the embodiments of the present specification.

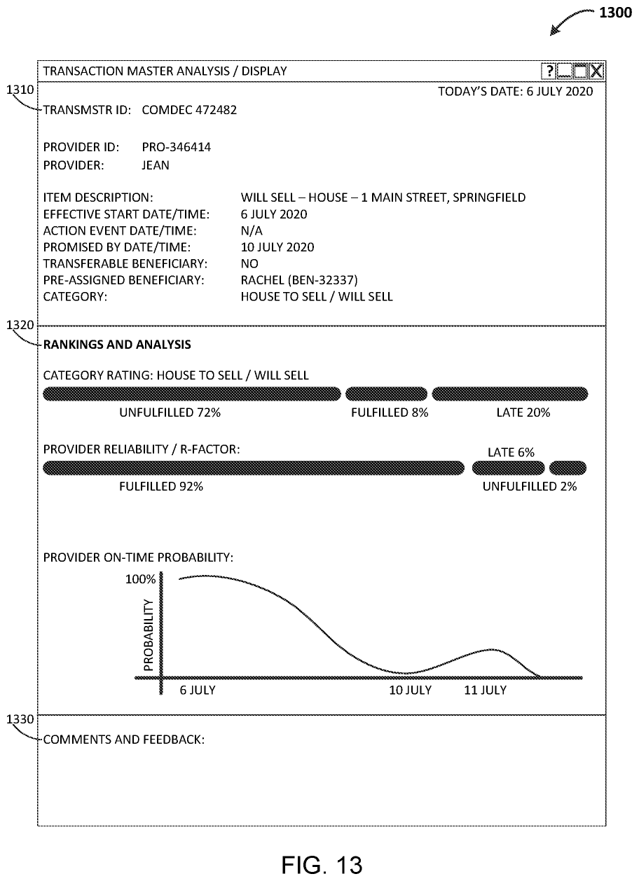

Referring to FIG. 13, therein depicted is a Transaction Master and Provider analysis of assurance account information illustrated as a database computer system screen entry and display according to the present invention. In particular, screen 1300 resembles a typical computer system screen display as a representation of details including, without limitation, personal information, item description and Transaction Master assurance terms and attributes 1310, constructed analysis results of rankings, ratings, and projections 1320, and comments and feedback 1330 data in the form of system information and correspondingly printed on screen 1300 to indicate the factors as executed and produced by assurance management server 170. Screen 1300 is a visual display form that is generated in a conventional way by or on behalf of assurance management server 170.

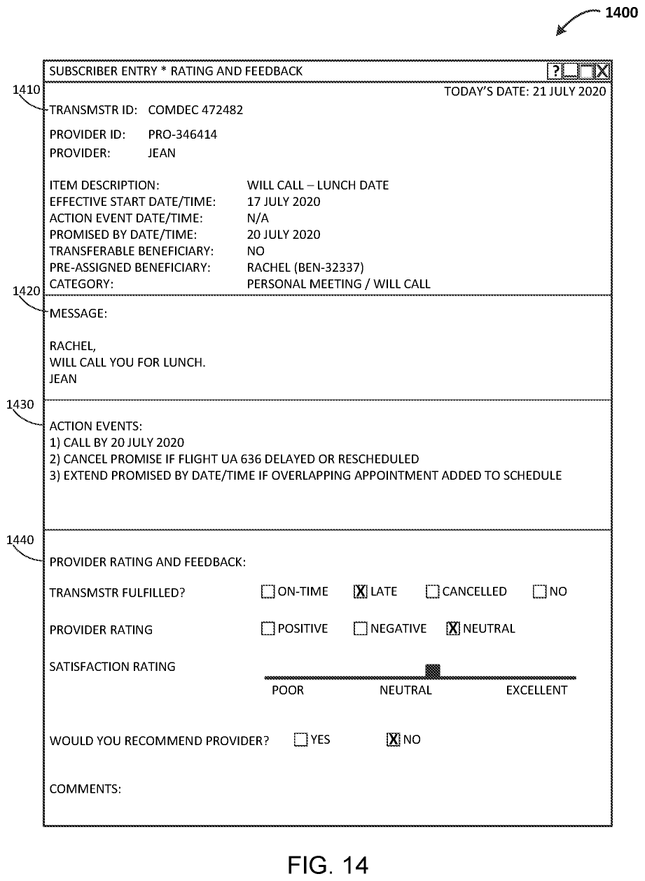

Referring now to FIG. 14, therein depicted is Subscriber rating and feedback account information record illustrated as a database computer system screen entry and display according to the present invention. In particular, screen 1400 resembles a typical computer system screen display as a representation of details including, without limitation, personal information and item description and Transaction Master attributes 1410, statement of assurance terms, acceptance options, rules and conditions 1420, events and times of notifications 1430, feedback and performance elements 1440 data in the form of system information and correspondingly printed on screen 1400 to indicate the utility and performance of a Provider and Transaction Master and Assurance Element. Screen 1400 is a visual display form that is generated in a conventional way by or on behalf of assurance management server 170.

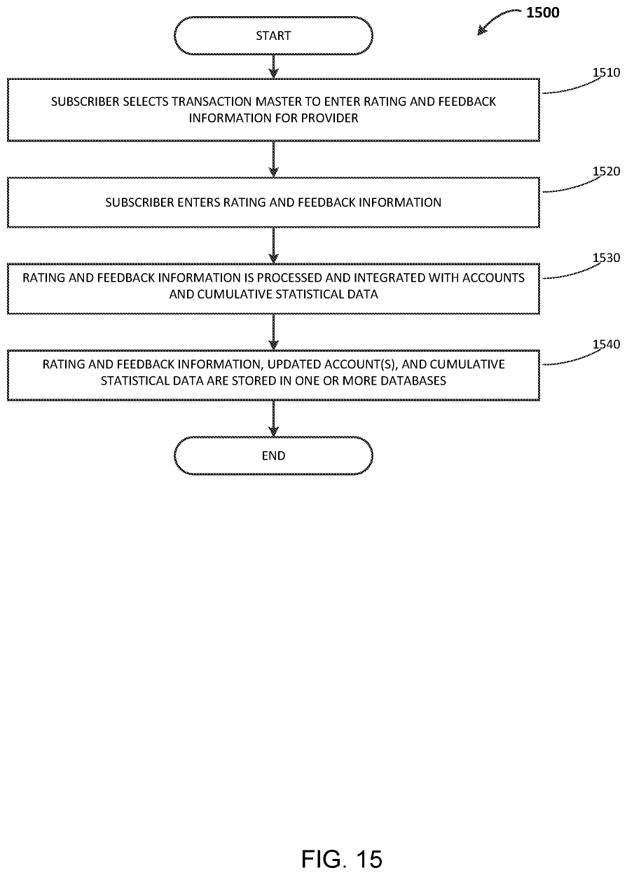

Referring to FIG. 15 therein illustrates an assurance management rating and feedback flow-diagram in accordance with the embodiments of the present specification. The method 1500 includes the following steps. In step 1510, a Subscriber selects a Transaction Master describing statements, items, Assurance Element, assurance terms, and other declaratory information. In step 1520, the Subscriber enters utility and performance ratings and feedback for a Provider and Transaction Master Assurance Element. In step 1530, the ratings and feedback information is processed and integrated with information of the Provider and Transaction Master. In step 1540, ratings and feedback information, updated accounts, and statistical data are stored in one or more databases of a storage device.

The flow-diagram described in FIG. 15 allows a Subscriber to access data located in a server and stored in one or more databases in order to create, update, access, receive, research, verify, or modify information, as performed by the Subscriber. Additional functions that may be available to the Subscriber include: automatically being notified of Transaction Master amendments and updates, tracking ratings against user-defined parameters, and asynchronously or interactively sharing feedback and messages regarding Providers and Subscribers or events which may impact the performance or ratings of a Transaction Master or associated parties.

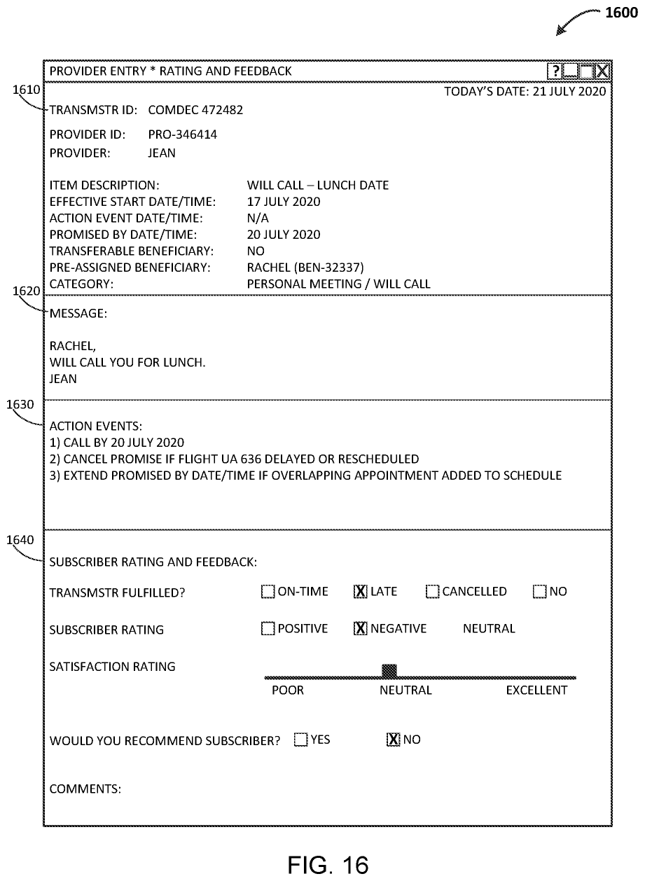

Referring now to FIG. 16, therein depicted is a Provider's rating and feedback information account record illustrated as a database computer system screen entry and display according to the present invention. In particular, screen 1600 resembles a typical computer system screen display as a representation of details including, without limitation, personal information and item description and Transaction Master attributes 1610, statement of assurance terms, Assurance Element, acceptance options, rules and conditions 1620, events and times of notifications 1630, feedback and performance elements 1640 data in the form of system information and correspondingly printed on screen 1600 to indicate the utility and performance of a Subscriber and Transaction Master and Assurance Element. Screen 1600 is a visual display form that is generated in a conventional way by or on behalf of assurance management server 170.

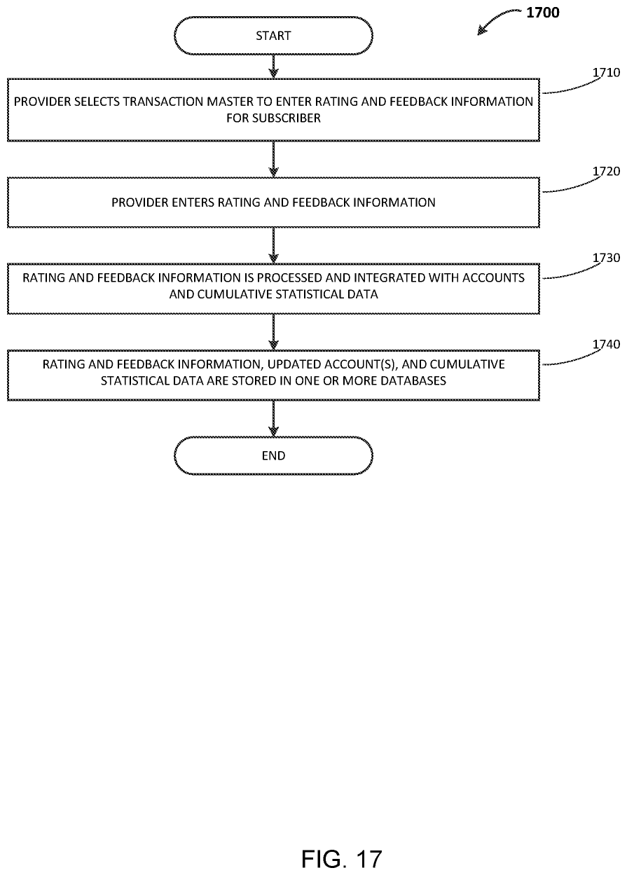

Referring to FIG. 17 therein illustrates an assurance management rating and feedback flow-diagram in accordance with the embodiments of the present specification. The method 1700 includes the following steps. In step 1710, a Provider selects a Transaction Master Assurance Element describing statements, items, assurance terms, and other declaratory information. In step 1720, the Provider enters utility and performance ratings and feedback of a Subscriber and Transaction Master. In step 1730, the ratings and feedback information is processed and integrated with information of the Subscriber and Transaction Master. In step 1740, ratings and feedback information, updated accounts, and statistical data are stored in one or more databases of a storage device.

The flow-diagram described in FIG. 17 allows a Provider to access data located in a server and stored in one or more databases in order to create, update, access, receive, research, verify, or modify information, as performed by the Provider. Additional functions that may be available to the Provider include: automatically being notified of Transaction Master amendments and updates, tracking ratings against user-defined parameters, and asynchronously or interactively sharing feedback and messages regarding Providers and Subscribers or events which may impact the performance or ratings of a Transaction Master or associated parties.

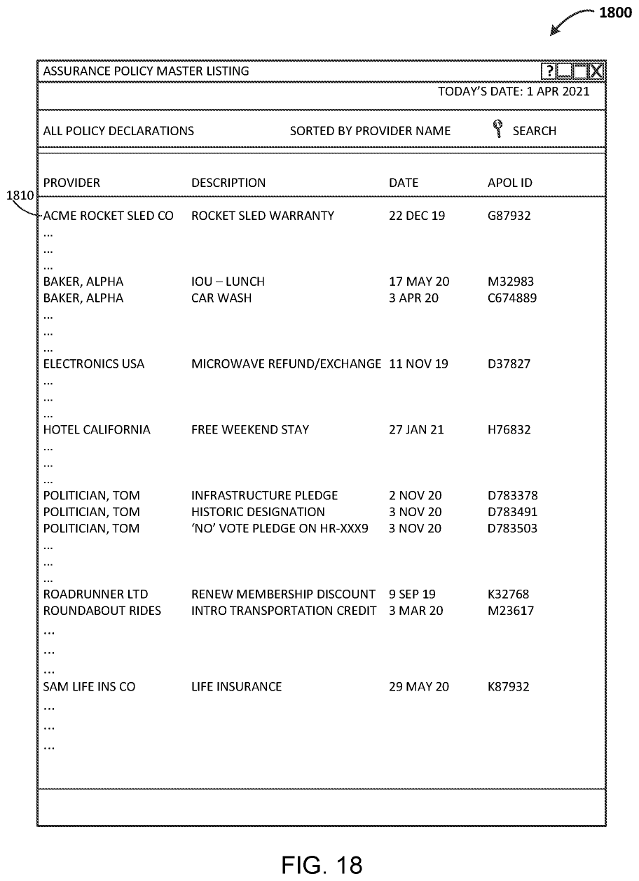

Referring now to FIG. 18, therein depicted is an Assurance Policy master listing of account record information illustrated as a database computer system screen entry and display according to the present invention. In particular, screen 1800 resembles a typical computer system screen display as a representation of details including, without limitation, Provider name, item description, and Assurance Element attributes 1810 in the form of system information and correspondingly printed on screen 1800 to list the available Assurance Policy. An Assurance Policy as displayed on screen 1800 may be selected by a Subscriber for display of further detailed information. Screen 1800 is a visual display form that is generated in a conventional way by or on behalf of assurance management server 170. Other forms of presentation (e.g., audio) are considered for use in all venues by the present invention.

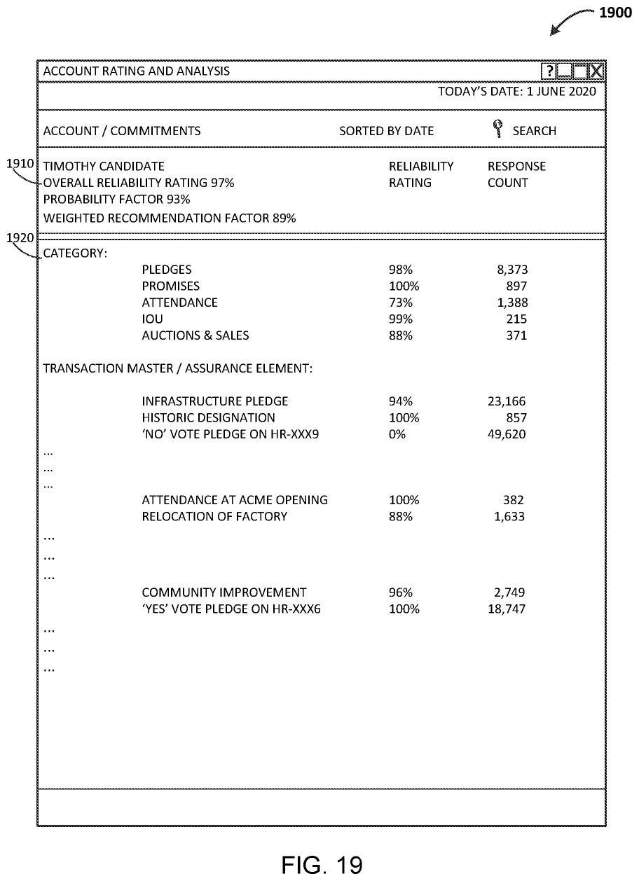

Referring to FIG. 19, therein depicted is a rating and analysis listing of account record information illustrated as a database computer system screen entry and display according to the present invention. In particular, screen 1900 resembles a typical computer system screen display as a representation of details including, without limitation, account selection of Provider, Subscriber, Host, or Beneficiary with related personal information, ratings, and projections 1910, listing of corresponding category, descriptions, and Transaction Master or Assurance Element attributes 1920 data in the form of system information and printed on screen 1900 to indicate the account's stored analysis, ratings, reviews, and performance factors. A category or Transaction Master or Assurance Element as displayed on screen 1900 may be selected by a user for further display of detailed information. Screen 1900 is a visual display form that is generated in a conventional way by or on behalf of assurance management server 170.

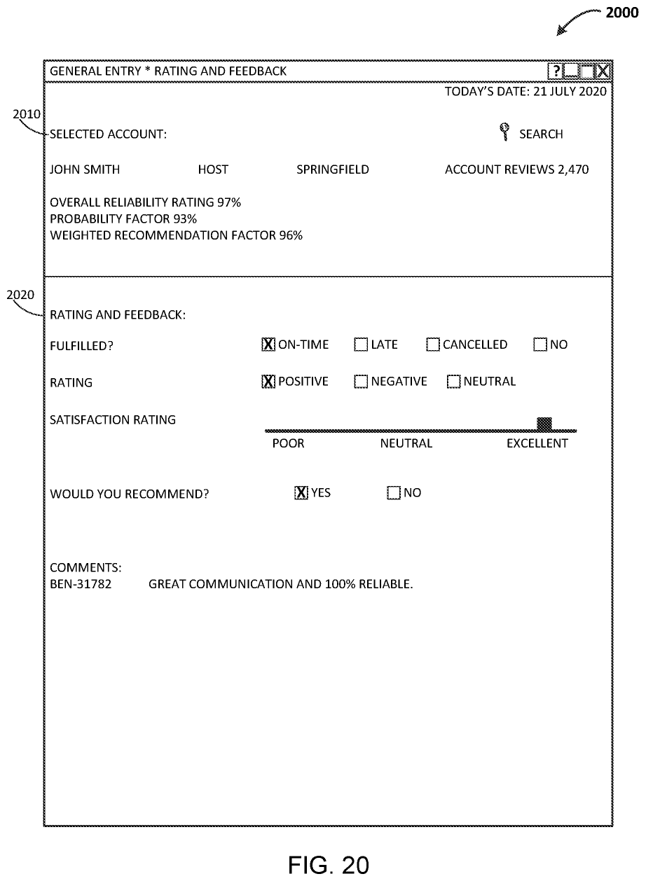

Referring now to FIG. 20, therein depicted is universal Subscriber rating and feedback account record information illustrated as a database computer system screen entry and display according to the present invention. A Subscriber can search and select any available account, with or without a related Transaction Master assignment, to provide feedback and ratings depending on privacy and association settings. In particular, screen 2000 resembles a typical computer system screen display as a representation of details including, without limitation, personal information, rating, ranking, and projection factors 2010, feedback and performance elements 2020 data in the form of system information and correspondingly printed on screen 2000 to indicate utility and performance. Screen 2000 is a visual display form that is generated in a conventional way by or on behalf of assurance management server 170.

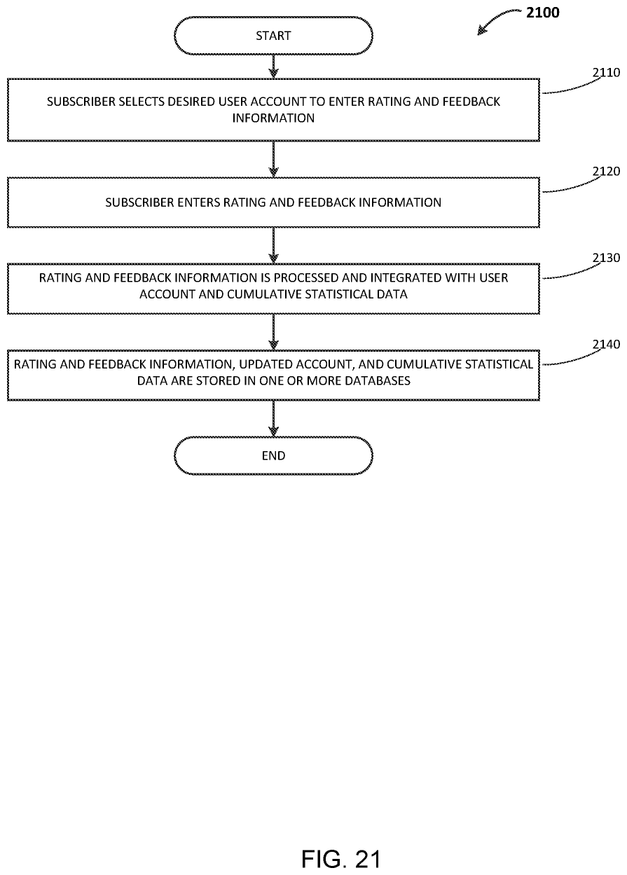

Referring to FIG. 21 therein illustrates an assurance management rating and feedback flow-diagram in accordance with the embodiments of the present specification. The method 2100 includes the following steps. In step 2110, a Subscriber selects a user account. In step 2120, the Subscriber enters utility and performance ratings and feedback for the selected user account. In step 2130, the ratings and feedback information is processed and integrated with existing information of the selected account. In step 2140, ratings and feedback information, updated account, and statistical data are stored in one or more databases of a storage device.

The flow-diagram described in FIG. 21 allows a Subscriber to access data located in a server and stored in one or more databases in order to create, update, access, receive, research, verify, or modify information, as performed by the Subscriber. Additional functions that may be available to the Subscriber include: asynchronously or interactively sharing feedback and messages regarding Subscribers or events which may impact the performance or ratings of a Transaction Master or associated parties.

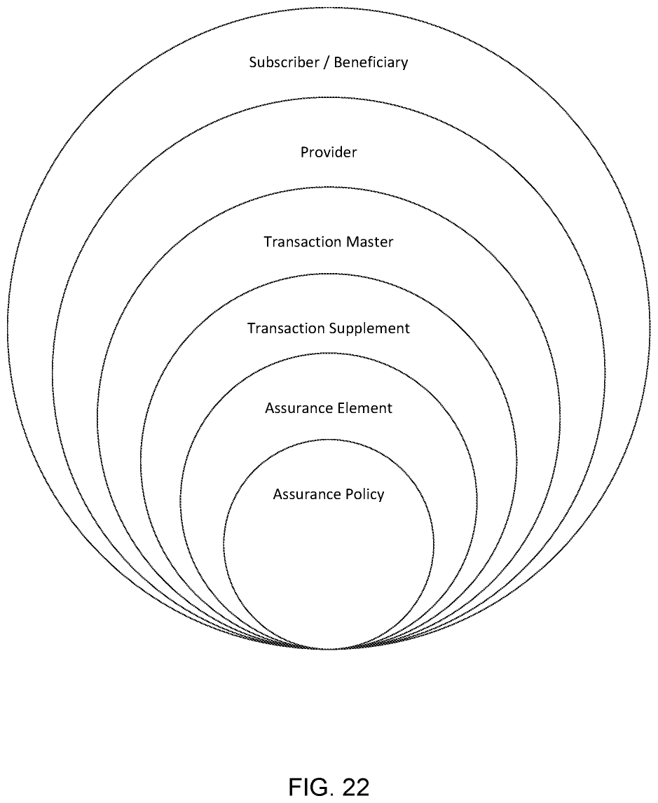

Referring now to FIG. 22 therein illustrates an assurance management system conceptual arrangement of the components in the present specification. The stacked Venn diagram illustrates how the encompassed features of the present invention are organized in a hierarchical order. A Subscriber or Beneficiary can be involved with one or more Provider. A Provider can produce one or more Transaction Master. A Transaction Master can include one or more Transaction Supplement. A Transaction Master or Transaction Supplement can include one or more Assurance Element. An Assurance Element can include one or more Assurance Policy and other details as conveyed by a Provider or Transaction Supplement, whether in isolation or combination of assurance terms. Variations of the arrangement are considered and evolving revisions may be performed by one skilled in the art of computer programming and database management systems.

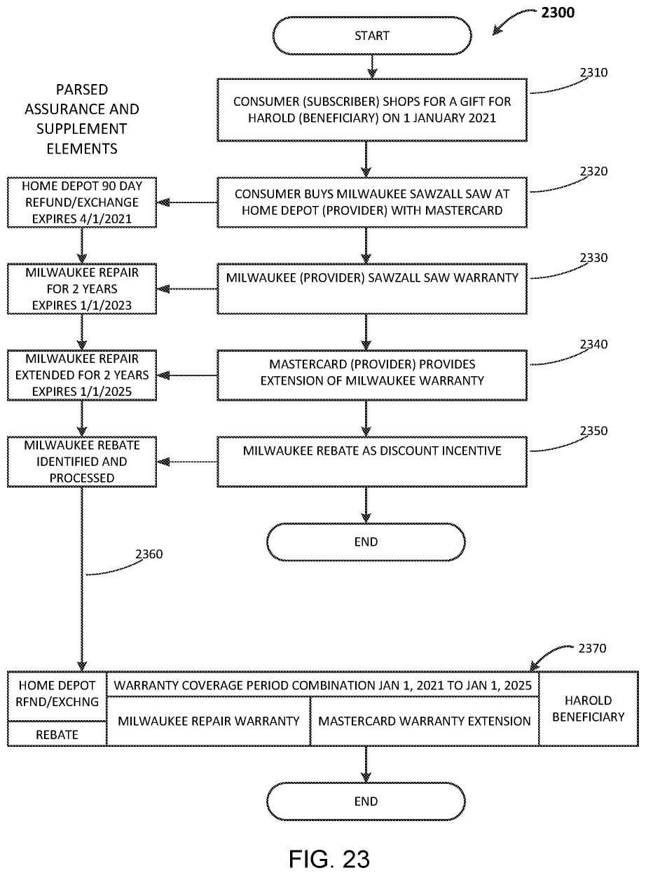

Referring to FIG. 23 therein illustrates an example of a product purchase flow-diagram as gift with integrated, combined, and extended assurance policies in accordance with the embodiments of the present specification. The method 2300 includes the following steps. In step 2310, a Subscriber proceeds to a HomeDepot store on 1 Jan. 2021 to purchase a Sawzall saw as a gift. In step 2320, the Subscriber buys a Milwaukee Sawzall saw at Home Depot paying with a MasterCard credit card. Home Depot provides a merchandise policy of a refund or exchange within 90 days from purchase date. In step 2330, the Milwaukee Sawzall saw manufacturer provides an assurance policy of free repairs for 2 years from the date of purchase. In step 2340, MasterCard provides an extension of a manufacturer warranty for up to 24 months matching the manufacturer warranty. In step 2350, a Milwaukee rebate is identified and processed for remittance. In step 2360, the system analyzes, determines combinable terms and options, then processes and transforms the combinable features and attributes into a newly formed and consolidated tokenized assurance chain structure as depicted in 2370. The token is recorded in the Subscriber's account and the Beneficiary appropriately notified. The state of transformation is novel since there is a conversion from one state of individual assurance elements to a newly formed tokenized structure of integrated holistic benefits. Just as different chemicals when combined create a new compound, so too does this present invention combine different term elements to create a new assurance structure.

The example of FIG. 23 displays the advancement, integration, and combination of dates while no such limitation of the present invention should be inferred. Any of features or attributes that may add, extend, encourage, or complement the one or more assurance terms, as may be offered by one or more Provider, are encompassed by the present invention. As example and not limitation, the use of various integration features and attributes, as well as dates, include advancement, integration, combination, complement, and extension options such as: added mileage allowance of a leased automobile; extended minutes awarded for game play; supplementary gigabytes of download allowance; bonus cloud-based storage capacity; extra transmission speed for data transfers; increased movie channel options; increased discount percentage rate; additional rebate amount; adjusted seating classification, such as advancing from coach to first class; extra paper clips; loyalty points; square-feet of storage space; awarding pounds of grass seed; or, adding size, color, or flavor to an object.

As further example, diverse product assurance metrics can be integrated with the present invention. Resperate.com offers a product to reduce a person's blood pressure. If blood pressure (i.e., the conditional assurance metric) is not reduced in 60 days, a consumer can get a full refund. The product also comes with a one year warranty. If a consumer pays for the product with a MasterCard credit card, then MasterCard will extend the manufacture warranty for one year. The present invention will coordinate and combine the conditional 60 day refund, one year manufacturer warranty, and one year MasterCard warranty to produce a combined assurance structure. Should this product be purchased as a gift, then the Beneficiary will be appended to the newly formed assurance structure for complete tracking and performance. It is evident that FIG. 23 could be recast as providing an assurance structure with the Resperate.com product and an activation condition of lowered blood pressure as an Oracle trigger. Monitoring data could be received by, as example, an IoT or Apple Watch sensor. There is no prior art that aligns such diverse metrics (i.e., blood pressure) with refunds or other actions.

The present invention identifies and distinguishes all assurance policy terms and supplements, and then aligns them with the appropriate combination of relatable assurance factors and features (e.g., points, power cycles, dates, classifications, discounts). When an action is required to claim an assurance term (e.g., refund of payment, monetary claim for damage), then the present invention will produce credentials as required indicating the combined assurance structure and elements.

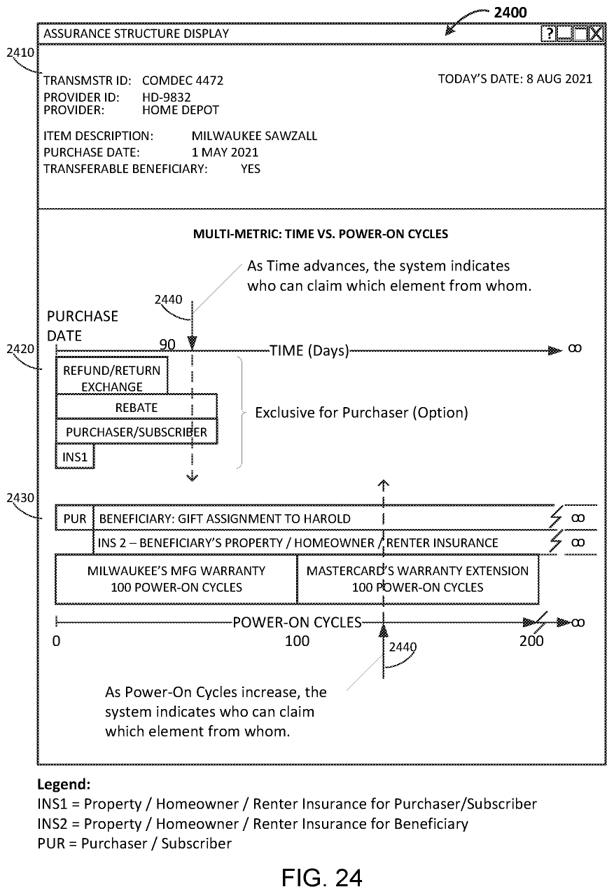

Referring to FIG. 24 therein depicted, as example, is one of many alternative assurance structure depictions for the one or more assurance metric. In particular, screen 2400 resembles a typical computer system screen display as a representation of Transaction Master logical and illustrative details including, without limitation, transaction and item information 2410, assurance options 2420 for Time metric, assurance options 2430 for Power-On Cycles metric, and action links. This example shows the variable indicators 2440 of Time and Power-On Cycles. There is an indication 2440 of who can make claim to which assurance element and from whom in accordance with the present invention. The system arranges and manages one or more metrics as prescribed by Assurance Providers. Additional metrics would likewise display to accommodate assurance specifications. Screen 2400 is a visual display form that is generated in a conventional way by or on behalf of assurance management server 170.

### Use Cases

### Promise—Will Sell by

As example and not limitation of an invention embodiment is a promise made between two people, such as a real estate broker and a house seller.

After a Monday lunch date, Alpha tells Baker “I'll sell your house by Friday for an 8% commission, or thereafter for a 3% commission.” Baker, wanting a fast sale, asks Alpha to enter the promise information into the present invention, or Baker may choose to enter such promise information with Alpha authentication (e.g., encryption code). By using analysis that integrates internal and external historical and current data sources, the present invention determines factors such as, without limitation, that such promises have a category rating of 72% failure rate, an 8% “sold within promised by date” success rate, and a 20% “sold after promised by date” delayed rate.

The present invention also may use internal and external historical and current data sources to calculate and produce a trustworthy factor of Alpha indicating that 92% of promises made by this person are fulfilled, 6% of promises are fulfilled late, and 2% or promises are unfulfilled. The present invention also may produce success projection rates indicating that on Monday there is a 97% probability Alpha will sell the house, by Tuesday it may be 82% getting a buyer, by Wednesday it may be 58% getting a buyer, by Thursday it may be 26%, and by Friday it may be 4%, with Saturday, the day after the “promised by date”, being 11% since Alpha has a 20% “sold after promised by date” probability ranking. Reference FIG. 13 as illustration of such factors.

Specific items that are extracted from promise information and submitted for processing would include, without limitation: date of assurance (e.g., when was a promise made); assurance item product, service, or action; item assurance terms, as appropriate; effective time periods; Host, as may be involved; settlement or acceptance method; party authentication; transmission method of Transaction Master; and, Provider and Subscriber identification.

Based on promise information entered, specific results of data processing would produce as appropriate, and without limitation, analysis factors of: current assurance item probability of success, failure, or delayed action (e.g., will a promise be fulfilled); Provider reliability factor for issuing and fulfilling assurances; projected assurance item probability of success, failure, or delayed action; and, integrated quality rating of Provider and Assurance Element.

A component of the present invention would allow Baker to provide feedback on Alpha as to when, or if, they sold the house. Alpha also would have an option to provide feedback on Baker as to whether they accepted a sale, declined a sale, and delayed a sale, among other actions or activities.

The present invention service will process and extract data from the promise information and create a data record of the communication and execute ratings, rankings, projections, and operational assignments in various storage systems as described in this specification. The communication information of the promise will be analyzed and transformed into ratings, rankings, and projections that will assist in the determination and development of planned and contingency actions by Subscriber.

The processing of communication information results in outputs that produce ratings, rankings, and projections that also may be used to establish trigger points for action.

A trigger point may include, without limitation, statistical probability levels which are used as a basis for action notifications. For example, an insurance policy expiration date could be processed into a statistical probability level indicating that a Subscriber should be notified of the expiration starting 8 days before the expiration date since that would be sufficient time to submit and have processed a policy renewal application, introduce amendments, or find a new Provider.

As another example, a washing machine warranty expiration date may be processed into a statistical probability level that triggers a notification to a Subscriber at 23 days before the warranty expiration date since that would be sufficient time to examine the washing machine for possible defects and request warranty-covered repairs. This transformation of information to proactive projection delivers something significantly beneficial to a Subscriber by revealing ratings, rankings, patterns, trends, and action features that increases the utility of Assurance Elements.

The processed trigger points could be used with internal, external, computed, or Subscriber-stated comparison factors such that when a processed trigger point was matched to a comparison factor the present invention system will generate and transmit a notification to appropriate parties or engage pre-programmed instructions.

### Insurance Policy—Smart Contract

An example, and not as limitation, of another invention embodiment is the application of an insurance contract as a “smart” contract. In this situation, an insurance policy issuer serves as Provider, a consumer serves as both Subscriber and Beneficiary.

A Provider creates a Transaction Master for an insurance policy that covers damage to an automobile. The Transaction Master designates the Subscriber as the assigned Beneficiary along with the grant of, among other assurances, a commitment assurance term to pay for repairs if the automobile is damaged. Settlement terms require a premium payment on the first of each month. The Subscriber agrees to and accepts the Transaction Master. The Transaction Master is transmitted to the present invention service which extracts and processes data from the transaction information and creates an assurance structure record as described in this specification.

The insurance policy Transaction Master is entered as a smart contract into one or more distributed-ledger system for monitoring, compliance, and actions. The distributed-ledger system includes an Oracle trigger which monitors for compliance of payment submission to the policy issuer. It is possible for preprogrammed Oracle instructions to be included that automatically makes payment prior to a default date, or notifies the Subscriber of an upcoming payment due. In the event of a Subscriber making a manual payment, if the Oracle trigger determines on the second day of a month that a manual payment has not been made, then programmed smart contract instructions that were entered into the distributed-ledger system would notify the Subscriber of the default or perform other programmed actions. The operations, processing, and logic of said smart contract provisions will be readily apparent to those skilled in the art of computer programming, distributed-ledger technologies, and database management systems.

### Product

An example, and not as limitation, of another invention embodiment is a product purchase. In this situation, a merchant serves as Host, a manufacturer serves as Provider (i.e., Transaction Supplement, Assurance Element), a re-assignable generic Beneficiary placeholder of “Buyer” serves as a pre-designated re-assignable Beneficiary, and a consumer serves as Subscriber. A Host creates a Transaction Master for a product (e.g., Walmart offering a microwave oven) for general distribution in the marketplace. The merchant offers a refund and exchange policy with the Transaction Master. The Transaction Master includes an assurance warranty statement indicating a pre-designated re-assignable Beneficiary (e.g., the Buyer).

The product, with Transaction Master, is exhibited to the public using, as example, the merchant Walmart as Host for display of the product in the merchant's establishment or website. Subscribers review the product and Transaction Master, and if agreed to, will accept the product and the Transaction Master in a settlement action. As assistance in a purchase, a Subscriber will have available the ratings of the Provider, Host, and, based on available information, the microwave oven product (i.e., Assurance Element) ratings.

At any time during the transaction process when the Host has exhibited the product and Transaction Master, either the Host, or a Subscriber considering the product and Transaction Master, may assign one or more Beneficiary to the Transaction Master as amendment, or as a right of making a Beneficiary designation (e.g., a gift purchase). A Subscriber that accepts the Transaction Master may assign all or part of the Transaction Master Assurance Element to one or more Beneficiary.

The present invention system and methods will execute a series of processes on the Transaction Master. Using an example of time periods, the Transaction Master will be parsed to identify the primary Provider (e.g., the Host) and determine any time periods related to an Assurance Policy (e.g., refund or exchange within 90 days). Further warranty options beyond time periods may include, as example and not limitation, power cycles, torque load, and environmental conditions as a sample of issues that may be conditional assurance topics.

To continue, the system will identify the Assurance Element (i.e., the microwave oven) for any related Assurance Policy (e.g., free repairs for 2 years). The system will continue to identify any Transaction Supplements (e.g., payment by MasterCard) and determine any related Assurance Policy related to the Assurance Element (i.e., microwave oven) and combine in chain-fashion any extension of benefits (e.g., manufacturer warranty time period extended by MasterCard up to 2 years). Processing continues to evaluate any further Transaction Supplements in a similar manner for warranty terms that may be applied or combined. The present invention will incorporate all such related benefits for the Assurance Element into a holistic assurance structure. All related components of the Transaction Master will be compiled according to this specification's processing system and appropriately tokenized and stored.

In the event of a defective product, a Subscriber or Beneficiary will be availed of the Transaction Master assurance terms as assigned. In this instance, the Subscriber or Beneficiary would be able to claim, as example, a refund, the exchange of product, a manufacturer warranty of service to repair or replace the product, or such other advantages as bestowed on the Subscriber or Beneficiary by the Transaction Master.

The present invention service will extract, process, and combine data from the transaction information and create a data record of the transaction and perform operational ratings, rankings, projections, assignments, and tokenization in various storage systems as described in this specification.

### PLEDGES AND STATEMENTS

An example, and not as limitation, of another invention embodiment is in the application of services related to a statement of undertaking or event occurrence. To wit, a created and presented Provider Transaction Master of a statement claiming “The sky is falling” (Sky) with an assurance benefit of the Provider paying $50 if the sky does fall and having a Subscriber pay the Provider $20 if the sky does not fall. In this example, a Provider creates and exhibits the Sky Transaction Master including a time period and other conditions for the occurrence of such event. When an interested one or more Subscriber chooses to accept and acquire the Sky Transaction Master, the Subscriber then settles and enters the Sky Transaction Master into their account and becomes an assigned Beneficiary with the Provider advised and linked to the Subscriber/Beneficiary account.

The Sky Transaction Master will be monitored as to the occurrence of the Sky falling event. One or more Beneficiaries will be availed of the ability, as provided by the present invention, to provide feedback on the accuracy, veracity, occurrence, and adherence to the Sky Transaction Master. A Provider may connect in order to provide feedback to any Subscriber account. Such a Sky Transaction Master example may be expanded to include instances of, for example, communications of politicians and their campaign pledges.

Should the Sky falling event occur, then the Provider will remit a $50 payment to a Subscriber/Beneficiary. If it does not occur, then the Subscriber/Beneficiary will remit a $20 payment to the Provider. The present invention integrates distributed ledger blockchain technology and, as such technology allows, provides a digital wallet that offers storage and processing of items encompassing, without limitation, currencies, objects, attributes and such components and features as accepted by a distributed ledger system.

The present invention service will extract, process, and combine data from the transaction information and create a data record of the transaction and perform operational ratings, rankings, projections, assignments, and tokenization in various storage systems as described in this specification.

What is claimed is:

1. A method for use in an assurance management system, said method employing computer means having processing means, data storage means, network communications means, and communication means with a distributed ledger of a distributed ledger network and comprising the steps of:
(a) a Subscriber, as a person, group, organization, human, legal, virtual, or contrived entity, creating an account record with requested information;
(b) a Provider, creating an account record with requested information, as an entity originating an Assurance Policy, specifying the terms of performance and one or more Assurance Element, as an individual object that includes one or more provision, feature, attribute, or specification, as designated by a Provider and to be conferred to a Subscriber or Beneficiary in operation with a Transaction Master, as a transaction envelope or wrapper for the Assurance Policy and Assurance Element to be recorded in the distributed ledger and being instantiated by one or more Provider;
(c) receiving a Transaction Master record containing an Assurance Policy and Assurance Element as originated from a Provider;
(d) identifying any Transaction Supplement, as one or more Provider being associated with the Transaction Master and offering supplemental Assurance Policy and Assurance Element, and integrating by means of chaining any supplementary Assurance Policy and Assurance Element to provide enhancement, extension, or continuity of any Assurance Policy or Assurance Element;
(e) creating a Tokenization, involving the process of converting data into a fungible or non-fungible encoded structure (token) and stored in a verifiable arrangement as developed in such compatible distributed ledger technologies, of the Transaction Master and storing a digital representation of the Transaction Master on a distributed ledger of a distributed ledger network storage; and
(f) providing access to the Transaction Master distributed ledger network storage for management, amendment, and query.

2. The method of claim 1 comprising the further step of Dynamic Assurance, the process of adjusting an established Assurance Policy or Assurance Element, by discovering, evaluating, and determining if additional Provider Assurance Policy or Assurance Element may be applied to a Transaction Master.

3. The method of claim 1 comprising the further step of analyzing the Transaction Master distributed ledger network storage to produce correlated Subscriber cohorts that may petition Provider for enhanced Assurance Policy or Assurance Element in dynamic fashion for inclusion and amendment to a Transaction Master.

4. The method of claim 1 comprising the further step of providing access to the Transaction Master distributed ledger network storage for Subscriber and Provider management.

5. The method of claim 1 comprising the further step of evaluating performance factors that may be computed by the assurance management system using historical and available data sources to provide statistical, probability, and projection assessments of the Provider, Subscriber, Beneficiary, Assurance Policy, and Assurance Element.

6. The method of claim 1 comprising the further step of monitoring Transaction Master Assurance Policy or Assurance Element and communicating notices, alerts, requirements, actions, expirations, and instructions as may be contained in the Transaction Master.

7. The method of claim 1 comprising the further step of assigning one or more Subscriber, and none or more Beneficiary, at the time of storing a Transaction Master, or at a time post-storage amending a Transaction Master.

8. The method of claim 7 comprising the further step whereby the Transaction Master, in whole or in part, may be assigned or reassigned to none or more Subscriber or Beneficiary with appropriate tokenization.

9. The method of claim 7 comprising the further step whereby Subscriber or Beneficiary assignments or amendments are stored on a distributed ledger of a distributed ledger network storage.

10. A computerized system of one or more processors, and one or more memories as adapted to store a plurality of machine-readable instructions which when executed by the one or more processors are adapted to cause the system to provide: assignment, analysis, authentication, encryption, tokenization, notification, storage, and management operations all as configured to process Transaction Master information; produce analysis, rating, and probability results of parties, Transaction Master, and Assurance Element; record available and related transaction information, rating, ranking, and probability results; the creation, authentication, and transfer of various token protocol objects; assignment of Transaction Master records to the designated Provider, Subscriber, Beneficiary; storage of Transaction Master records on a distributed ledger of a distributed ledger network storage; verifiably pairing a Transaction Master record with a digital representation comprising: a computer system in communication with a distributed ledger of a distributed ledger network; a first data capture device in communications with the computer system; a second device in communication with the computer system; a set of computer readable instructions included in the computer system configured for: creating a first Transaction Master record from the first data capture device including, a first Provider, a first Subscriber, a first time, a first Assurance Policy, one or more first Assurance Element, none or more Beneficiary, and a first set of performance factors wherein the first Transaction Master record includes a first digital representation of a first Transaction Master record captured by the first data capture device, and, storing the first Transaction Master record on the distributed ledger of a distributed ledger network storage for access by a second device in communication with the computer system.

11. The computerized system of claim 10 wherein the set of computer readable instructions include instructions for receiving the Transaction Master data that includes any of portrayals of goods, services, information, terms, conditions, limitations, effective time periods, covenants, restrictions, policies, instructions, procedures, and associated data that relates to the nature of the Assurance Policy or Assurance Element.

12. The computerized system of claim 10 wherein the set of computer readable instructions include instructions for receiving external data from an external data source associated with sources from the group consisting of public records, enterprise software, a local computer device, distributed ledger network, and remote computer device and any combination thereof in communication with the computer system.

13. The computerized system of claim 12 wherein the external data includes scores, ratings, commentary, performance evaluations, personal information, and financial information as related to the parties associated with a Transaction Master record.

14. The computerized system of claim 10 wherein the set of computer readable instructions include instructions for calculating a rating and a probability spectrum for the parties associated with a Transaction Master using available data, assigning such rating and probability spectrum to the parties associated with a Transaction Master and assigning such rating and probability spectrum to the Transaction Master record, and storing the results on the distributed ledger of a distributed ledger network storage.

15. The computerized system of claim 10 wherein the set of computer readable instructions include:
(a) means for recording data of users, transactions, analysis results, and commentary;
(b) means for receiving requests to process transactions;
(c) means for enabling user access to information;
(d) means for producing Transaction Master records on a distributed ledger of a distributed ledger network storage;
(e) means for processing notices, alerts, requirements, actions, expirations, and instructions as may be contained in the Transaction Master record;
(f) means for transmitting information to users by any available modality;
(g) means for consummating transactions; and,
(h) means for receiving, recording, and storing user information and transaction activity.
